(19) United States
(12) Patent Application Publication
(10) Pub. No.: US 2020/0331196 A1
(43) Pub. Date: Oct. 22, 2020

(54) 3D PRINTING OF CATALYTIC FORMULATION FOR SELECTIVE METAL DEPOSITION

(71) Applicant: Stratasys Ltd., Rehovot (IL)

(72) Inventors: Efraim DVASH, Rehovot (IL); Ira YUDOVIN-FARBER, Rehovot (IL); Eynat MATZNER, Adi (IL)

(73) Assignee: Stratasys Ltd., Rehovot (IL)

(21) Appl. No.: 16/916,188

(22) Filed: Jun. 30, 2020

Related U.S. Application Data
(63) Continuation of application No. PCT/IL2018/051418, filed on Dec. 31, 2018.
(60) Provisional application No. 62/612,464, filed on Dec. 31, 2017.

(51) Int. Cl. B29C 64/112; B33Y 10/00; B33Y 40/20; B33Y 70/00; B29C 64/30; B33Y 30/00; C23C 18/30

(52) U.S. Cl. CPC B29C 64/112; B33Y 10/00; B33Y 40/20; B29K 2505/14; B29C 64/30; B33Y 30/00; C23C 18/30; B33Y 70/00

(57) ABSTRACT

Described herein is a method of additive manufacturing of a three-dimensional object having an agent which promotes electroless metal deposition dispersed therein in a configured pattern. The method utilizes modeling material formulation(s) which comprise and/or are capable of generating such an agent. Further described is a method of manufacturing a three-dimensional object having an electrically-conductive material dispersed in a configured pattern. The method utilizes an object having an agent which promotes electroless metal deposition dispersed therein in a configured pattern and manufactured by the aforementioned method, and proceeds by contacting the three-dimensional object with an electroless deposition solution so as to effect the electroless deposition onto the configured pattern. Further described are kits for use in additive manufacturing as described herein; as well as three-dimensional objects which may be manufactured as described herein.

### RELATED APPLICATIONS

This application is a Continuation of PCT Patent Application No. PCT/IL2018/051418 having International filing date of Dec. 31, 2018, which claims the benefit of priority under 35 USC § 119(e) of U.S. Provisional Patent Application No. 62/612,464 filed on Dec. 31, 2017. The contents of the above applications are all incorporated by reference as if fully set forth herein in their entirety.

### FIELD AND BACKGROUND OF THE INVENTION

The present invention, in some embodiments thereof, relates to additive manufacturing and, more particularly, but not exclusively, to formulations and methods usable in additive manufacturing of a three-dimensional object which comprises electrically-conductive material.

Additive manufacturing is generally a process in which a three-dimensional (3D) object is manufactured utilizing a computer model of the objects. Such a process is used in various fields, such as design related fields for purposes of visualization, demonstration and mechanical prototyping, as well as for rapid manufacturing (RM).

The basic operation of any AM system consists of slicing a three-dimensional computer model into thin cross sections, translating the result into two-dimensional position data and feeding the data to control equipment which manufacture a three-dimensional structure in a layerwise manner.

Various AM technologies exist, amongst which are stereolithography, digital light processing (DLP), and three-dimensional (3D) printing, 3D inkjet printing in particular. Such techniques are generally performed by layer by layer deposition and solidification of one or more building materials, typically photopolymerizable (photocurable) materials.

In three-dimensional printing processes, for example, a building material is dispensed from a dispensing head having a set of nozzles to deposit layers on a supporting structure. Depending on the building material, the layers may then solidify, harden or cured, optionally using a suitable device.

Various three-dimensional printing techniques exist and are disclosed in, e.g., U.S. Pat. Nos. 6,259,962, 6,569,373, 6,658,314, 6,850,334, 7,183,335, 7,209,797, 7,225,045, 7,300,619, 7,479,510, 7,500,846, 7,962,237 and 9,031,680, all of the same Assignee, the contents of which are hereby incorporated by reference.

A printing system utilized in additive manufacturing may include a receiving medium and one or more printing heads. The receiving medium can be, for example, a fabrication tray that may include a horizontal surface to carry the material dispensed from the printing head. The printing head may be, for example, an inkjet head having a plurality of dispensing nozzles arranged in an array of one or more rows along the longitudinal axis of the printing head. The printing head may be located such that its longitudinal axis is substantially parallel to the indexing direction. The printing system may further include a controller, such as a microprocessor to control the printing process, including the movement of the printing head according to a pre-defined scanning plan (e.g., a CAD configuration converted to a Stereo Lithography (STL) format and programmed into the controller). The printing head may include a plurality of jetting nozzles. The jetting nozzles dispense material onto the receiving medium to create the layers representing cross sections of a 3D object.

In addition to the printing head, there may be a source of curing energy, for curing the dispensed building material. The curing energy is typically radiation, for example, UV radiation.

Additionally, the printing system may include a leveling device for leveling and/or establishing the height of each layer after deposition and at least partial solidification, prior to the deposition of a subsequent layer.

The building materials may include modeling materials and support materials, which form the object and the temporary support constructions supporting the object as it is being built, respectively.

The modeling material (which may include one or more material(s)) is deposited to produce the desired object/s and the support material (which may include one or more material(s)) is used, with or without modeling material elements, to provide support structures for specific areas of the object during building and assure adequate vertical placement of subsequent object layers, e.g., in cases where objects include overhanging features or shapes such as curved geometries, negative angles, voids, and so on.

Both the modeling and support materials are preferably liquid at the working temperature at which they are dispensed, and subsequently harden or solidify, typically upon exposure to curing energy (e.g., UV curing), to form the required layer shape. After printing completion, support structures are removed to reveal the final shape of the fabricated 3D object.

Several additive manufacturing processes allow additive formation of objects using more than one modeling material, also referred to as “multi-material” AM processes. For example, U.S. Patent Application having Publication No. 2010/0191360, of the present Assignee, discloses a system which comprises a solid freeform fabrication apparatus having a plurality of dispensing heads, a building material supply apparatus configured to supply a plurality of building materials to the fabrication apparatus, and a control unit configured for controlling the fabrication and supply apparatus. The system has several operation modes. In one mode, all dispensing heads operate during a single building scan cycle of the fabrication apparatus. In another mode, one or more of the dispensing heads is not operative during a single building scan cycle or part thereof.

In a 3D inkjet printing process such as Polyjet™ (Stratasys Ltd., Israel), the building material is selectively jetted from one or more printing heads and deposited onto a fabrication tray in consecutive layers according to a pre-determined configuration as defined by a software file.

U.S. Pat. No. 9,227,365, by the present assignee, discloses methods and systems for solid freeform fabrication of shelled objects, constructed from a plurality of layers and a layered core constituting core regions and a layered shell constituting envelope regions.

The Polyjet™ technology allows control over the position and composition of each voxel (volume pixel), which affords enormous design versatility and digital programming of multi-material structures. Other advantages of the Polyjet™ technology is the very high printing resolution, up to 14 μm layer height, and the ability to print multiple materials simultaneously, in a single object. This multi-material 3D printing process often serves for fabrication of complex parts and structures that are comprised of elements having different stiffness, performance, color or transparency. New range of materials, programmed at the voxel level, can be created by the PolyJet™ printing process, using only few starting materials.

In order to be compatible with most of the commercially-available printing heads utilized in a 3D inkjet printing system, the uncured building material should feature the following characteristics: a relatively low viscosity (e.g., Brookfield Viscosity of up to 50 centipoise, or up to 35 centipoise, preferably from 8 to 25 centipoise) at the working (e.g., jetting) temperature; surface tension of from about 25 to about 55 dyne/cm, preferably from about 25 to about 40 dyne/cm; and a Newtonian liquid behavior and high reactivity to a selected curing condition, to enable fast solidification of the jetted layer upon exposure to a curing condition, of no more than 1 minute, preferably no more than 20 seconds. Additional requirements include low boiling point solvents (if solvents are used), e.g., featuring a boiling point lower than 200 or lower than 190° C., yet characterized preferably by low evaporation rate at the working (e.g., jetting) temperature, and, if the building material includes solid particles, these should feature an average size of no more than 2 microns.

Current PolyJet™ technology offers the capability to use a range of curable (e.g., polymerizable) materials that provide polymeric materials featuring a variety of properties, ranging, for example, from stiff and hard materials (e.g., curable formulations marketed as the Vero™ family materials) to soft and flexible materials (e.g., curable formulations marketed as the Tango™ and Agilus™ families), and including also objects made using Digital ABS, which contain a multi-material made of two starting materials (e.g., RGD515 & RGD535/531), and simulate properties of engineering plastic. Most of the currently practiced PolyJet™ materials are curable materials which harden or solidify upon exposure to radiation, mostly UV radiation and/or heat.

In order to expand 3D printing and make it more versatile, new processes should be developed to enable deposition of a broader range of materials, including electrically conductive materials, and/or catalytic materials which are usable in electroless plating.

Electroless plating refers to the use of chemical reactions in an aqueous solution for effecting metal plating, such as copper-plating or nickel-plating, without external electrical power. Electroless plating is commonly catalyzed by particles of a noble metal, such as gold, silver, palladium, platinum or ruthenium. An example of electroless plating involves the use of palladium to catalyze reduction of Cu²⁺ to metallic copper in the presence of formaldehyde.

Electroless plating typically lacks specificity towards any region on a surface being plated. In order to block plating on a portion of a surface, protective layers may be added manually to mask such portions of the surface.

In laser direct structuring (LDS), a laser writes the course of a circuit trace on plastic doped with a non-conductive metallic compound. Metal particles form where the laser beam hits the plastic, and act as nuclei for subsequent metallization in an electroless deposition solution.

Chinese Patent Application Publication No. 104442057 describes a method of forming a metallized pattern by inkjet printing a noble metal catalyst ink, followed by formation of a metal on the portion with the ink by electroless plating. Mold interconnect assemblies formed by such a method are also described therein.

Japanese Patent No. 5843992 describes a transfer film for electroless plating. The transfer film comprises a layer comprising a catalyst such as palladium, platinum or silver particles, as well as an adhesive layer. Upon transferring the catalyst layer and adhesive layer to a substrate, electroless plating of the substrate can be performed.

Liao & Kao [ACS Appl Mater Interfaces 2012, 4:5109-5113] describes a method of creating conductive copper thin films on polymer surfaces, by printing and drying micropatterns of silver nitrate ink on flexible plastic surfaces, followed by immersion of the plastic in an electroless copper plating bath at 55° C. for two minutes.

Cook et al. [Electronic Materials Letters 2013, 9:669-676] describes a process for fabricating copper-based microwave components, such as antennas, on flexible paper-based substrates, using an inkjet printer to deposit a catalyst-bearing solution in a desired pattern on paper, followed by immersion of the catalyst-bearing paper in an aqueous copper-bearing solution to allow for electroless deposition of a compact and conformal layer of copper in the inkjet-derived pattern.

Kamyshny et al. [Open Appl Phys J 2011, 4:19-36] reviews applications of metal-based inkjet inks for printed electronics, and describes preparation of inks containing metal nanoparticles, complexes and metallo-organic compounds, and obtaining conductive patterns by using various sintering methods.

Additional background art includes U.S. Pat. No. 5,512,162 and U.S. Patent Application Publication Nos. 2016/243621 and 2010/0191360.

### SUMMARY OF THE INVENTION

According to an aspect of some embodiments of the invention, there is provided a method of additive manufacturing of a three-dimensional object having an agent which promotes electroless metal deposition dispersed in and/or on at least a portion thereof, the method comprising sequentially forming a plurality of layers in a configured pattern corresponding to the shape of the object, thereby forming the object, wherein the agent is dispersed in and/or on the abovementioned portion of the object in a secondary configured pattern,

wherein the formation of at least a few of the layers comprises:

dispensing a first modeling material formulation which comprises a first curable material; and

dispensing a second modeling material formulation which comprises a second curable material and the agent which promotes electroless metal deposition,

wherein dispensing the first and the second modeling material formulations is according to the secondary configured pattern.

According to an aspect of some embodiments of the invention, there is provided a method of manufacturing of a three-dimensional object comprising an electrically-conductive material dispersed in and/or on at least a portion of the object in a secondary configured pattern, the method comprising:

forming, by additive manufacturing according to the method described herein (according to any of the respective embodiments), a three-dimensional object having an agent which promotes electroless metal deposition dispersed in and/or on at least a portion thereof in the secondary configured pattern; and

contacting the three-dimensional object having an agent which promotes electroless metal deposition dispersed in and/or on at least a portion thereof in the secondary configured pattern with an electroless deposition solution capable of forming an electrically-conductive layer in the presence of the agent, to thereby form the electrically-conductive material in and/or on the surface of the object according to the secondary configured pattern.

According to an aspect of some embodiments of the invention, there is provided a three-dimensional object having an agent which promotes electroless metal deposition dispersed in and/or on at least a portion thereof in a configured pattern, manufactured according to the respective method described herein (according to any of the respective embodiments).

According to an aspect of some embodiments of the invention, there is provided a three-dimensional object having an agent which promotes electroless metal deposition dispersed in a configured pattern on an internal surface of the object.

According to an aspect of some embodiments of the invention, there is provided a three-dimensional object having an electrically-conductive material dispersed in and/or on at least a portion thereof in a configured pattern, manufactured according to the respective method described herein (according to any of the respective embodiments).

According to an aspect of some embodiments of the invention, there is provided a three-dimensional object having an electrically-conductive material dispersed in a configured pattern on an internal surface of the object.

According to an aspect of some embodiments of the invention, there is provided a kit for use in additive manufacturing, the kit comprising a modeling material formulation which comprises a curable material and an agent which promotes electroless metal deposition.

According to some embodiments of any of the embodiments of the invention relating to a method, the method further comprises exposing the dispensed modeling material formulations to a curing condition, to thereby form a hardened first modeling material formulation and a hardened second modeling material formulation.

According to some embodiments of any of the embodiments of the invention relating to a method, the curable material is a UV-curable material, and the curing condition comprises UV radiation.

According to some embodiments of any of the embodiments of the invention relating to a method, the second modeling material formulation comprises a support material formulation, the method further comprising removing a portion of the support material formulation.

According to some embodiments of any of the embodiments of the invention relating to a second modeling material formulation comprising a support material formulation, a mixed layer is formed upon contact of the support material formulation and the first modeling material formulation, the mixed layer comprising the support material formulation and first second modeling material formulation in admixture.

According to some embodiments of any of the embodiments of the invention relating to a method utilizing a second modeling material formulation comprising a support material formulation, the method further comprises treating the support material formulation with an oxidant to form the agent which promotes electroless metal deposition.

According to some embodiments of any of the embodiments of the invention relating to a method, the method further comprises dispensing a support material formulation adjacent to the second modeling material formulation.

According to some embodiments of any of the embodiments of the invention relating to a method, a mixed layer is formed upon contact of the support material formulation and the second modeling material formulation, the mixed layer comprising the support material formulation and the second modeling material formulation in admixture.

According to some embodiments of any of the respective embodiments of the invention, the method further comprises removing at least a portion of the support material formulation. According to some embodiments of any of the respective embodiments of the invention, the curable material comprises a (meth)acrylic material.

According to some embodiments of any of the respective embodiments of the invention, the first modeling material formulation and the second modeling material formulation further comprise a photoinitiator.

According to some embodiments of any of the respective embodiments of the invention, a photoinitiator concentration in the second modeling material formulation is at least twice a photoinitiator concentration in the first modeling material formulation.

According to some embodiments of any of the respective embodiments of the invention, the secondary configured pattern is on an external surface of the object.

According to some embodiments of any of the respective embodiments of the invention, at least a portion of the secondary configured pattern is on an internal surface of the object.

According to some embodiments of any of the respective embodiments of the invention, the agent is a catalyst of electroless metal deposition, and a concentration of the agent in the second modeling material formulation is in a range of from 1 to 10 weight percents.

According to some embodiments of any of the respective embodiments of the invention, the catalyst comprises silver particles and/or palladium particles.

According to some embodiments of any of the respective embodiments of the invention, the second modeling material formulation further comprises at least one surfactant.

According to some embodiments of any of the embodiments of the invention relating to electroless metal deposition, the respective method further comprises activating the agent in the secondary configured pattern prior to contacting with an electroless deposition solution, to thereby form an activated catalyst of electroless metal deposition dispersed in the object in the secondary configured pattern.

According to some embodiments of any of the respective embodiments of the invention relating to electroless metal deposition, activating the agent comprises forming Pd(0) on a solid phase of the agent.

According to some embodiments of any of the respective embodiments of the invention, activating is effected by contacting the agent with an activating substance comprising Pd(II). According to some embodiments of any of the respective embodiments of the invention, the activating substance comprises PdCl₂ and HCl.

According to some embodiments of any of the respective embodiments of the invention relating to electroless metal deposition, activating is effected by contacting the agent with an activating substance comprising silver particles.

According to some embodiments of any of the respective embodiments of the invention, the agent comprises silver particles.

According to some embodiments of any of the respective embodiments of the invention, the agent comprises palladium particles.

According to some embodiments of any of the embodiments of the invention relating to particles, the particles comprise nanoparticles.

According to some embodiments of any of the respective embodiments of the invention, the activating substance comprises a catalyst of electroless metal deposition, and the agent binds to the catalyst, to thereby form the activated catalyst bound to the agent.

According to some embodiments of any of the respective embodiments of the invention, the agent that binds to the catalyst comprises a carboxylic acid group.

According to some embodiments of any of the embodiments of the invention relating to electroless metal deposition, the respective method further comprises treating the object having an agent which promotes electroless metal deposition dispersed in and/or on at least a portion thereof in the secondary configured pattern with a chemical etchant solution prior to contacting with an electroless deposition solution.

According to some embodiments of any of the respective embodiments of the invention, the etchant comprises a permanganate.

According to some embodiments of any of the respective embodiments of the invention, a concentration of the permanganate is at least 0.5 weight percents.

According to some embodiments of any of the respective embodiments of the invention, the respective method further comprises contacting the object with a bleaching composition subsequent to treating with the etchant.

According to some embodiments of any of the respective embodiments of the invention, the bleaching composition comprises a peroxide and an acid.

According to some embodiments of any of the respective embodiments of the invention, the electroless deposition solution comprises a metal ion and a reducing agent.

According to some embodiments of any of the respective embodiments of the invention, the metal of the electroless deposition solution is selected from the group consisting of copper, nickel, silver and gold.

According to some embodiments of any of the respective embodiments of the invention, the reducing agent of the electroless deposition solution is selected from the group consisting of an aldehyde and a hypophosphite.

According to some embodiments of any of the respective embodiments of the invention, the metal ion of the electroless deposition solution is copper ion and the reducing agent of the electroless deposition solution is formaldehyde.

According to some embodiments of any of the respective embodiments of the invention, the electrically-conductive material is characterized by a resistivity of no more than 10⁻⁷ Ω*m.

According to some embodiments of any of the embodiments of the invention relating to a kit, the curable material is a UV curable material, and the kit further comprises a photoinitiator.

According to some embodiments of any of the embodiments of the invention relating to a kit, the photoinitiator described herein and the modeling material formulation are packaged individually within the kit.

According to some embodiments of any of the respective embodiments of the invention, the kit further comprises a modeling material formulation which does not comprise the agent.

According to some embodiments of any of the embodiments of the invention relating to a kit, each of the modeling material formulations in the kit is packaged individually within the kit.

According to some embodiments of any of the respective embodiments of the invention, the kit further comprises an activating substance capable of activating the agent which promotes electroless metal deposition, to thereby form an activated catalyst of electroless metal deposition.

According to some embodiments of any of the embodiments of the invention relating to a kit, the activating substance described herein is packaged individually within the kit.

According to some embodiments of any of the respective embodiments of the invention, the kit further comprises an electroless deposition solution capable of forming an electrically-conductive material in the presence of the agent.

According to some embodiments of any of the embodiments of the invention relating to a kit, the solution is packaged individually within the kit.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-D are schematic illustrations of an additive manufacturing system according to some embodiments of the invention;

FIGS. 2A-2C are schematic illustrations of printing heads, including nozzle arrays, according to some embodiments of the present invention;

FIGS. 3A-3B are schematic illustrations demonstrating coordinate transformations according to some embodiments of the present invention;

FIGS. 4A-4E present a flow chart (FIG. 4A) showing an exemplary manufacturing process according to some embodiments of the invention; as well as a schematic depiction (FIGS. 4B-4E) of an exemplary additive manufacturing process of forming tunnels coated with electroless-deposited copper, according to some embodiments of the present invention, wherein an exemplary printing system (FIG. 4B) forms a printed object with catalytic ink (FIG. 4C) which is treated with an exemplary electroless copper deposition solution (FIG. 4D) to obtain a final object with selective copper deposition (FIG. 4E);

FIGS. 5A-5J present images of 3D objects printed with modeling material formulation which comprises catalytic silver nanoparticles, prepared according to some embodiments of the invention (prior to electroless plating);

FIG. 6 presents images of a 3D-printed object, formed according to some embodiments of the present invention, and subjected to activation by a 2% Ag nanoparticle solution and selective electroless deposition of copper on a printed pattern on the object's surface, upon treatment by exposure for 1 hour (at room temperature) to 2% NaOH, 2% HCl, 2% KMnO₄, 2% H₂SO₄, 10% formaldehyde (CH₂O) or without treatment (Ref);

FIGS. 7A-7C present images of a 3D-printed object with a lower part printed in matte mode and an upper part printed in glossy mode, formed according to some embodiments of the present invention without including a formulation containing silver particles, shortly after printing and washing with a water jet (FIG. 7A), after treatment by exposure to 2% KMnO₄ for 1 hour (at room temperature) (FIG. 7B), and after selective electroless copper deposition by activation by a 2% Ag solution for 10 minutes, washing with deionized water and soaking in electroless deposition solution for 1 hour (FIG. 7C);

FIG. 8 presents images of a 3D-printed object, formed according to some embodiments of the present invention, and subjected to activation by a 2% Ag nanoparticle solution and selective electroless deposition of copper on a printed central pattern on the object's surface, upon treatment by exposure to 0.1%, 0.5%, 1% or 2% KMnO₄;

FIG. 9 presents an image of capacitive sensors according to two different designs (top left and bottom left, respectively), formed according to some embodiments of the present invention, by subjecting a 3D-printed intermediate to activation by a 2% Ag nanoparticle solution and selective electroless deposition of copper on a printed pattern on the intermediate's surface, upon treatment with 5% KMnO₄; as well as corresponding 3D-printed intermediates (top right and bottom right, respectively) with the printed pattern containing Ag nanoparticles (brown-gray portion) prior to treatment with KMnO₄, activation and electroless deposition;

FIG. 10 presents an image of an antenna (left), formed according to some embodiments of the present invention, by subjecting a 3D-printed intermediate to activation by a 2% Ag nanoparticle solution and selective electroless deposition of copper on a printed pattern on the intermediate's surface, upon treatment with 5% KMnO₄; as well as a 3D-printed intermediate (right) with the printed pattern containing Ag nanoparticles (brown-gray portion) prior to treatment with KMnO₄, activation and electroless deposition;

FIG. 11 shows signal power (in decibels) as a function of frequency (from 0.8 to 4 GHz) in the presence (lines showing negative peaks) or absence (flat line) of an antenna such as depicted in FIG. 10 (the two lines showing negative peaks represent duplicate measurements of same sample);

FIG. 12 presents an image of 3D-printed intermediates in the preparation of components of an electromagnetic (EMI) shield, with a printed pattern containing Ag nanoparticles (the component at left is designed to fit on top of the component at right);

FIG. 13 presents an image of components of 3 electromagnetic (EMI) shields, each of the two components of the shields (shown at left (left 3 components) and at right (right three components), respectively), being formed according to some embodiments of the present invention, by subjecting a 3D-printed object such as shown in FIG. 12 to activation by an Ag nanoparticle solution and selective electroless deposition of copper on a printed pattern on the object's surface, upon treatment with KMnO₄; and

FIG. 14 presents an image of an exemplary 3D-printed object (bottom), formed according to some embodiments of the present invention, and subjected to activation by a PdCl₂ solution and electroless deposition of copper on a printed pattern on the object's surface; as well as a 3D-printed intermediate (top) with Ag nanoparticles on surface prior to activation and electroless deposition.

### DESCRIPTION OF SPECIFIC EMBODIMENTS OF THE INVENTION

The present invention, in some embodiments thereof, relates to freeform fabrication and, more particularly, but not exclusively, to formulations and methods usable in freeform fabrication of an object comprising an electrically-conductive layer.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Although a wide variety of materials may be incorporated into objects formed by freeform fabrication, such materials tend to be organic polymers. Incorporation of electrical functionality into such objects has therefore posed a considerable challenge.

The present inventors have uncovered, following laborious experimentation, that additive manufacturing may be used to advantageously incorporate electrical functionality in a selective and controllable manner, by using the additive manufacturing to selectively and controllably disperse an agent which promotes electroless metal deposition. The additive manufacturing may thus be followed by electroless metal deposition which forms an electrically-conductive material on a surface of the object formed by additive manufacturing.

While reducing the present invention to practice, the inventors have formed three-dimensional objects with a wide variety of external and/or internal surfaces, and utilized same to selectively form electrically-conductive material in a wide variety of external and/or internal patterns, which may be utilized in a myriad of applications and functional electrical devices, including antennas, capacitors, electrical circuits, electromagnetic shields, and the like.

The method of the present embodiments comprises manufacturing three-dimensional objects in a layerwise manner by forming a plurality of layers in a configured pattern corresponding to the shape of the objects, as described herein.

The three-dimensional object manufactured in a layerwise manner is made of the modeling material or a combination of modeling materials or a combination of modeling material/s and support material/s or modification thereof (e.g., following curing). All these operations are well-known to those skilled in the art of solid freeform fabrication.

According to an aspect of some embodiments of the invention, there is provided a method of additive manufacturing of a three-dimensional object having an agent which promotes electroless metal deposition dispersed in and/or on at least a portion thereof. The method comprises sequentially forming a plurality of layers in a configured pattern corresponding to the shape of the object, thereby forming the object, wherein the agent which promotes electroless metal deposition is dispersed in and/or on the portion of the object in a secondary configured pattern.

Sequential forming of a plurality of layers in a configured pattern corresponding to the shape of the object is generally effected such that formation of each of at least a few of said layers, or of each of said layers, comprises dispensing a building material (uncured) which comprises one or more modeling material formulations, and exposing the dispensed modeling material(s) to a curing condition (e.g., curing energy) to thereby form a hardened modeling material, as described in further detail hereinafter.

Herein throughout, the phrases “building material formulation”, “uncured building material”, “uncured building material formulation”, “building material” and other variations therefore, collectively describe the materials that are dispensed to sequentially form the layers, as described herein. This phrase encompasses uncured materials dispensed so as to form the object, namely, one or more uncured modeling material formulation(s), and uncured materials dispensed (in part or solely) so as to form the support, namely uncured support material formulations.

Herein throughout, the phrase “cured modeling material” or “hardened modeling material” describes the part of the building material that forms the object, as defined herein, upon exposing the dispensed building material to curing, and, optionally, if a support material has been dispensed, also upon removal of the cured support material, as described herein. The cured modeling material can be a single cured material or a mixture of two or more cured materials, depending on the modeling material formulations used in the method, as described herein.

The phrase “cured modeling material” or “cured modeling material formulation” can be regarded as a cured building material wherein the building material consists only of a modeling material formulation (and not of a support material formulation). That is, this phrase refers to the portion of the building material which is used to provide the final object.

Herein throughout, the phrase “modeling material formulation”, which is also referred to herein interchangeably as “modeling formulation”, “model formulation” “model material formulation” or simply as “formulation”, describes a part or all of the building material which is dispensed so as to form the object, as described herein. The modeling material formulation is an uncured modeling formulation (unless specifically indicated otherwise), which, upon exposure to curing condition, forms the object or a part thereof.

In some embodiments of the present invention, a modeling material formulation is formulated for use in three-dimensional inkjet printing (e.g., featuring rheological, thermal and physical properties that meet the requirements of a 3D inkjet printing system and process) and is able to form a three-dimensional object on its own, i.e., without having to be mixed or combined with any other substance.

An uncured building material can comprise one or more modeling formulations, and can be dispensed such that different parts of the object are made, upon curing, of different cured modeling formulations or different combinations thereof, and hence are made of different cured modeling materials or different mixtures of cured modeling materials.

The formulations forming the building material (modeling material formulations and support material formulations) comprise one or more curable materials (as defined herein), which, when exposed to a curing condition, form hardened (cured) material (as described in detail herein).

According to some embodiments of any of the respective embodiments described herein, formation of at least a few of the layers (as described herein) comprises dispensing a first modeling material formulation which comprises a first curable material; and dispensing a second modeling material formulation which comprises a second curable material and said agent which promotes electroless metal deposition, wherein dispensing the first and second modeling material formulations is according to the secondary configured pattern.

As exemplified herein, a second modeling material formulation may be similar to or even identical to a support material formulation (e.g., comprising or consisting of a support material formulation). For example, a portion of such a formulation which is later removed (according to any of the embodiments described herein relating to removal of a support) may optionally function as a support material formulation, whereas a portion of such a formulation which is retained in the final object may optionally function as a second modeling material formulation. A portion of such formulation may be selectively retained (e.g., in a secondary configured pattern described herein), for example, by formation of a mixed layer upon contact of the support material formulation and the first modeling material formulation, the mixed layer comprising the support material formulation and first second modeling material formulation in admixture.

For brevity, the phrase “agent which promotes electroless metal deposition” is used herein interchangeably with the phrase “electroless deposition promoter”.

Herein and in the art, the phrases “electroless metal deposition”, “electroless deposition” and “electroless plating” (which are used herein interchangeably), as well as variations thereof, refer to a process whereby a metal (e.g., copper, nickel, silver and/or gold) is deposited on a surface without using external electrical power (e.g., as is used in electroplating). Typically, electroless deposition is effected by reduction of a metal ion by a reducing compound, such as formaldehyde (rather than by application of external electric power), under suitable conditions (e.g., as described herein).

The secondary configured pattern according to any of the respective embodiments described herein may have any shape, size and location consistent with the geometry of the three-dimensional object, and may be on an external surface of the object, on an internal surface of the object or wherein a portion is on an external surface and a portion is on an internal surface.

Indeed, manufacturing according to a method described herein may be particularly advantageous in allowing one to readily control a shape, size and location of deposited electroless deposition promoter and/or conducting material deposited thereon (e.g., according to any of the respective embodiments described herein). In particular, internal surfaces are particularly difficult to subject to deposition of an electroless deposition promoter and/or to electroless deposition, by alternative methodologies.

Herein, an “internal surface” of an object refers to a surface or portion of a surface wherein an outer-pointing normal to the surface (i.e., a line perpendicular to the surface and pointing away from the bulk defined by the surface) passes through another portion of the object. As each point on a surface has its own normal, the internal surface refers to an area wherein the normal for all points therein meets the above definition.

The internal surfaces herein are preferably open to an external environment (e.g., continuous with an external surface), so as to facilitate electroless deposition on the internal surface (e.g., upon contact with a suitable solution applied externally).

Examples of internal surfaces include, without limitation, surfaces in tunnels and sufficiently concave regions such as cavities and pits (e.g., wherein a normal to one side of a tunnel or cavity passes through an opposite side of the tunnel or cavity). It is noted that an opening of a tunnel, cavity or pit may or may not be an internal surface as defined herein, and that a shallow concave region might not comprise an internal surface as defined herein in even a portion thereof.

According to an aspect of some embodiments of the invention, there is provided a three-dimensional object having an agent which promotes electroless metal deposition dispersed in and/or on at least a portion thereof in a configured pattern. In some such embodiments, the three-dimensional object is manufactured according to a method described herein (according to any of the respective embodiments herein relating to a method of additive manufacturing such an object).

In some of any of the respective embodiments described herein, the three-dimensional object has an agent which promotes electroless metal deposition dispersed in a configured pattern (which is at least in part) on an internal surface of the object (according to any of the respective embodiments herein relating to an internal surface).

Electroless Metal Deposition:

According to an aspect of some embodiments of the invention, there is provided a method of manufacturing of a three-dimensional object comprising an electrically-conductive material dispersed in and/or on at least a portion of the object in a secondary configured pattern. The method comprises forming, by additive manufacturing (according to any of the embodiments described herein relating to a method of additive manufacturing), a three-dimensional object having an electroless deposition promoter (as defined herein, according to any of the respective embodiments) dispersed in and/or on the portion of the object in the secondary configured pattern; and contacting the three-dimensional object having a dispersed electroless deposition promoter with an electroless deposition solution capable of forming an electrically-conductive layer in the presence of the electroless deposition promoter, to thereby form the electrically-conductive material in and/or on the surface of the object according to the secondary configured pattern.

The secondary configured pattern in which the electrically-conductive material is dispersed is substantially the same as the secondary pattern in which the electroless deposition promoter is dispersed (according to any of the respective embodiments described herein); i.e., at least 80% (and optionally at least 90%, at least 95%, at least 98%, at least 99%, and even 100%) of each secondary configured pattern overlaps with the other secondary configured pattern. Thus, control over the dispersion of the electroless deposition promoter facilitates control over the electrically-conductive material location.

Herein, the phrase “electrically-conductive material” refers to the ability of a material to conduct electricity, wherein the “material” is defined according to the type of material (the intrinsic properties of the material, including any impurities therein) as well as the amount and macroscopic distribution of the material.

For example, a macroscopic distribution of the electrically-conductive material may be such that it is formed from particles of an (intrinsic) electrical conductor or semiconductor. Such particles may optionally, but not obligatorily, be connected so as to form a continuous bulk, such as a film. Alternatively, the material comprises distinct particles (rather than a continuous bulk), at least a portion of the which are in sufficient proximity and/or contact so as to allow electrical conduction between distal portions of the material, although many portions of the material may optionally be incapable of participating in such conduction (e.g., electrically insulated from the rest of the material).

The electrical conductor or semiconductor is characterized by a (bulk) resistivity of no more than 1000 Ω*m (ohm*meter), optionally no more than 1 Ω*m, optionally no more than 10⁻³ Ω*m, optionally no more than 10⁻⁵ Ω*m, optionally no more than 10⁻⁶ Ω*m, and optionally no more than 10⁻⁷ Ω*m. Examples of metals characterized by a resistivity of no more than 10⁻⁷ Ω*m include, without limitation, silver, copper, gold, aluminum, tungsten, zinc, nickel and iron. Copper, an exemplary conductor, has a resistivity of about 1.7*10⁻⁸ Ω*m.

The electrically-conductive material may optionally be characterized by a ratio of resistivity of the electrically-conductive material to the resistivity of the (bulk) resistivity of the conductor or semiconductor from which the electrically-conductive material is formed (by deposition). Generally, such a ratio is at least 1, as imperfections in the electrically-conductive material may increase resistivity relative to the bulk material. Resistivity of the electrically-conductive material may be determined according to any suitable technique known in the art.

In some embodiment, resistivity of the electrically-conductive material is no more than 20-fold (e.g., from 2-fold to 20-fold, or from 3-fold to 20-fold) a (bulk) resistivity of the conductor or semiconductor from which the electrically-conductive material is formed. In some embodiment, resistivity of the electrically-conductive material is no more than 15-fold (e.g., from 2-fold to 15-fold, or from 3-fold to 15-fold) a resistivity of the conductor or semiconductor from which the electrically-conductive material is formed. In some embodiment, resistivity of the electrically-conductive material is no more than 10-fold (e.g., from 2-fold to 10-fold, or from 3-fold to 10-fold) a resistivity of the conductor or semiconductor from which the electrically-conductive material is formed. In some embodiment, resistivity of the electrically-conductive material is no more than 5-fold (e.g., from 2-fold to 5-fold, or from 3-fold to 5-fold) a resistivity of the conductor or semiconductor from which the electrically-conductive material is formed.

For example, in embodiments wherein resistivity of the electrically-conductive material formed from copper deposition is no more than 20-fold (e.g., according to any of the respective embodiments described herein) a bulk resistivity of copper (which is about 1.7*10⁻⁸ Ω*meter), the resistivity of the electrically-conductive material is no more than about 3.4*10⁻⁷ Ω*meter. The bulk resistivity of relevant materials other than copper will be known to the skilled person.

In some embodiment, resistivity of the electrically-conductive material is no more than 20 Ω*m, optionally no more than 2*10⁻² Ω*m, optionally no more than 2*10⁻⁴ Ω*m, optionally no more than 2*10⁻⁵ Ω*m, optionally no more than 2*10⁻⁶ Ω*m, optionally no more than 10⁻⁶ Ω*m, optionally no more than 5*10⁻⁷ Ω*m, optionally no more than 2*10⁻⁷ Ω*m, and optionally no more than 10⁻⁷ Ω*m.

The electrically-conductive material may optionally be characterized by sheet resistance, which is known in the art as a useful parameter for comparing thin materials of various sizes (as it is applicable to two-dimensional systems and is invariable under scaling). The sheet resistance reflects both the type of the material as well as the macroscopic distribution (e.g., layer thickness and degree of continuity) of the material.

Sheet resistance refers to the electrical resistance of a square portion of a material (e.g., in units of ohms (a)), and may be regarded as resistivity (e.g., in units of Ω*m) divided by sheet thickness (e.g., in units of m). It is noted that the term “ohms” in the context of a sheet resistance is used interchangeably in the art with the terms “ohms per square” and “ohms/□”, in order to differentiate units of sheet resistance from units of resistance of a bulk material (although ohm units and ohm per square units are dimensionally equal).

The electrically-conductive material is characterized by a sheet resistance of no more than 1000Ω, optionally no more than 100Ω, optionally no more than 10Ω, and preferably no more than 5Ω (e.g., in a range of from 0.001 to 5Ω, or from 0.01 to 5Ω).

In some embodiments, the electrically-conductive material is characterized by a sheet resistance of no more than 3Ω (e.g., in a range of from 0.001 to 3Ω). In some embodiments, the sheet resistance is no more than 2Ω (e.g., in a range of from 0.001 to 2Ω). In some embodiments, the sheet resistance is no more than 1Ω (e.g., in a range of from 0.001 to 1Ω). In some embodiments, the sheet resistance is no more than 0.5Ω (e.g., in a range of from 0.001 to 0.5Ω). In some embodiments, the sheet resistance is no more than 0.25Ω (e.g., in a range of from 0.001 to 0.25Ω). In some embodiments, the sheet resistance is no more than 0.1Ω (e.g., in a range of from 0.001 to 0.1Ω).

The sheet resistance may be determined according to any suitable technique known in the art, such as by four-terminal sensing measurement (a.k.a. four-point probe measurement). The sheet resistance is preferably determined for a square of at least 0.1 mm, and optionally at least 1 mm, in length, so as to accurately reflect macroscopic properties.

Herein, the phrase “electroless deposition solution” refers to a solution capable of effecting electroless metal deposition on a surface upon contact with the surface.

In some embodiments, the electroless deposition comprises a metal ion and a reducing agent, optionally in aqueous solution. Many suitable electroless deposition solutions are commercially available, and the skilled person will be readily capable of determining properties suitable for effecting electroless metal deposition upon contact (e.g., suitable metal ion concentration, reducing agent species and concentration thereof, solvent and/or pH).

Examples of suitable metal ions include, without limitation, copper, nickel, silver and gold, for example in a form of a salt thereof.

Examples of suitable reducing agents include, without limitation, aldehydes and hypophosphites. Formaldehyde is an exemplary reducing agent for electroless deposition, for example, for electroless deposition of copper (in the presence of copper ions).

Herein, the term “hypophosphite” refers to a compound comprising a H₂P(═O)O⁻ ion, for example sodium hypophosphite or potassium hypophosphite salt.

Hypophosphites are particularly suitable, for example, for electroless deposition of nickel (e.g., nickel alloyed with phosphorus).

In some of any of the respective embodiments described herein, the method further comprises activating the agent which promotes electroless metal deposition (in a secondary configured pattern) prior to contacting the agent with an electroless deposition solution. Such activation forms an activated catalyst of electroless metal deposition dispersed in the secondary configured pattern.

Herein, “activating” an electroless deposition promoter refers to a process which increases a catalytic activity thereof, such that an “activated” catalyst is one which is a more effective catalyst of electroless metal deposition than the electroless deposition promoter prior to activating.

In some of any of the respective embodiments, activating an electroless deposition promoter comprises forming Pd(0) (palladium in metallic form) on a solid phase of the electroless deposition promoter, for example, wherein the electroless deposition promoter is a metal and/or particle (according to any of the respective embodiments described herein). In some such embodiments, the electroless deposition promoter comprises particles of a metal other than palladium (e.g., silver)—such that the activated catalyst may optionally be a palladium-coated metal (e.g., palladium-coated silver).

Without being bound by any particular theory, it is believed that Pd(0) is highly effective in catalyzing electroless deposition, such that formation of Pd(0) on another catalytic substance (e.g., silver) typically enhances the catalytic activity thereof, thereby converting a simple catalyst to an activated catalyst.

Pd(0) may optionally be formed on the electroless deposition promoter (e.g., silver particles) by contacting the electroless deposition promoter with an activating substance comprising Pd(II), for example, PdCl₂, under suitable conditions (e.g., under acidic conditions, for example, wherein the activating substance further comprises an acid such as HCl).

Alternatively or additionally, in some of any of the respective embodiments, activating an electroless deposition promoter comprises contacting the electroless deposition promoter with an activating substance which also comprises a catalyst of electroless deposition, for example, in a form of particles (e.g., silver particles). In some embodiments, the activating substance and the electroless deposition promoter comprise the same substance, for example, wherein both comprise silver particles.

Without being bound by any particular theory, it is believed that electroless deposition promoter in and/or on a surface may act as nucleation centers onto which an activating substance is selectively deposited (e.g., when both comprise the same metal), thereby effectively increasing the concentration electroless deposition promoter (e.g., silver particles) in the secondary configured patterned; such that the activated catalyst may optionally comprise agglomerates and/or larger particles of a catalyst.

In some of any of the respective embodiments, an activating substance comprises a catalyst of electroless metal deposition (e.g., a catalyst according to any of the respective embodiments described herein), and the electroless deposition promoter is an agent which binds to such a catalyst. Notably, such an electroless deposition promoter does not necessarily comprise a catalyst of electroless deposition per se. Rather, such an electroless deposition promoter may optionally promote electroless deposition by binding to the catalyst of the activating substance in a desired location (e.g., within a secondary configured pattern), such that the activated catalyst may optionally be a catalyst bound to the agent which promotes electroless metal deposition.

In some embodiments, an electroless deposition promoter which binds to a catalyst of an activating substance (e.g., a metal particle) comprises a functional group suitable for binding to such a catalyst. A suitable functional group may be one which is highly polar, for example, a carboxylic acid group (which may be in protonated or deprotonated form).

In some embodiments, an electroless deposition promoter which binds to a catalyst of an activating substance (e.g., a metal particle) comprises a first functional group (e.g., hydroxyl) which is converted to a second functional group (e.g., carboxylic acid) suitable for binding to a catalyst, upon treatment of the three-dimensional object, for example, by an oxidant. Treatment with an oxidant may optionally be a treatment with a chemical etchant (which is also an oxidant), such as a permanganate, according to any of the respective embodiments described herein.

In some embodiments, an electroless deposition promoter which binds to a catalyst of an activating substance (e.g., either per se or upon treatment with an oxidant) is a curable material, such that the electroless deposition promoter is comprised by the second curable material (of the second modeling material formulation). Upon curing, such an electroless deposition promoter may optionally be incorporated (e.g., by cross-linking and/or polymerization) into the modeling material formulation.

In some of any of the respective embodiments, a second modeling material formulation which comprises an electroless deposition promoter which binds to a catalyst of an activating substance (e.g., either per se or upon treatment with an oxidant) comprises a support material formulation, according to any of the embodiments described herein relating to a modeling material formulation which comprises a support material formulation.

Acrylic acid, methacrylic acid and oligomers thereof are non-limiting examples of curable materials which comprise a carboxylic acid group, and are capable of serving as an electroless deposition promoter. Upon curing, an acrylic acid or methacrylic acid electroless deposition promoter may become an acrylic acid residue or methacrylic acid residue, respectively.

In some of any of the respective embodiments described herein, the method further comprises treating an object having an electroless deposition promoter dispersed in a secondary configured pattern (according to any of the respective embodiments described herein) with a chemical etchant (e.g., in solution) prior to contacting with an electroless deposition solution.

Treatment with a chemical etchant is referred to herein interchangeably as “etching”.

Etching may optionally be effected prior to and/or subsequently to activating an electroless deposition promoter according to any of the respective embodiments described herein (if such activating is effected). In exemplary embodiments, etching is effected prior to activating an electroless deposition promoter.

It is to be appreciated that such etching may optionally enhance efficacy of an electroless deposition promoter, and thus may be regarded as being a form of activating an electroless deposition promoter itself (e.g., wherein the etchant is type of activating substance such as described herein). Such activation by etching may optionally be effected in addition to (prior to and/or subsequent to), or instead of, other types of electroless deposition promoter activation described herein (according to any of the respective embodiments).

Without being bound by any particular theory, it is believed that etching may activate an electroless deposition promoter by removing material which may obstruct contact with an electroless deposition solution (e.g., curable material enveloping at least a portion of the electroless deposition promoter).

However, etching is generally described herein as a distinct treatment, rather than a type of electroless deposition promoter activation. It is to be understood that this terminology is merely for convenience (as many exemplary embodiments comprise both etching and activation by other agents), and is not intended to suggest that etching does not activate the electroless deposition promoter to at least some extent.

Many suitable chemical etchants are known in the art, and the skilled person will be readily capable of determining which chemical etchants are suitable for a given modeling material formulation (e.g., capable of etching the curable material(s) therein).

Examples of suitable chemical etchants include, without limitation, permanganates (i.e., compounds comprising MnO₄⁻ ion), for example, ammonium permanganate, calcium permanganate, sodium permanganate, and potassium permanganate, and combinations thereof. Potassium permanganate (KMnO₄) is an exemplary etchant.

Etching is optionally effected with a permanganate (e.g., KMnO₄) solution, wherein a concentration of the permanganate is at least 0.5 weight percent (e.g., from 0.5 to 10 weight percents or 0.5 to 20 weight percents), optionally at least 1 weight percent, optionally at least 2 weight percents, and optionally at least 4 weight percents. In some exemplary embodiments, a concentration of permanganate is about 5 weight percents.

Additional examples of suitable chemical etchants include, without limitation, perchlorates (i.e., compounds comprising ClO₄⁻ ion), chromates (i.e., compounds comprising CrO₄⁻ ion) and dichromates (i.e., compounds comprising Cr₂O₇²⁻ ion).

In some of any of the embodiments described herein relating to etching (e.g., etching with a permanganate), the object is contacted with a bleaching composition subsequent to etching, optionally in order to at least partially reverse a color change induced by the etching.

The bleaching composition may optionally comprise a peroxide (e.g., H₂O₂), and/or an acid (e.g., a strong acid such as H₂SO₄ and the like). In some embodiments, a concentration of the acid is at least 0.5 weight percent, optionally at least 1 weight percent, optionally at least 2 weight percents, and optionally at least 4 weight percents (e.g., about 5 weight percents). Exemplary bleaching compositions comprise H₂O₂ and H₂SO₄.

According to an aspect of some embodiments of the invention, there is provided a three-dimensional object having an electrically-conductive material dispersed in and/or on at least a portion thereof in a configured pattern. In some such embodiments, the three-dimensional object is manufactured according to a method described herein (according to any of the respective embodiments herein relating to a method of manufacturing such an object).

In some of any of the respective embodiments described herein, the three-dimensional object has an electrically-conductive material dispersed in a configured pattern (which is at least in part) on an internal surface of the object (according to any of the respective embodiments herein relating to an internal surface).

Modeling Material Formulations and Formulation System:

Curable Material:

As described herein, methods according to some embodiments described herein comprise dispensing a plurality of modeling material formulations comprising a curable material, e.g., a first modeling material formulation which comprises a first curable material, and a second modeling material formulation which comprises a second curable material (as well as an agent which promotes electroless metal deposition).

Herein, the phrase “formulation system” is used to collectively refer to such a plurality of modeling material formulations comprising curable materials.

The first curable material (of the first modeling material formulation) and the second curable material (of the second modeling material formulation) may optionally be the same material or different materials. For example, the first curable material and the second curable material may optionally be the same material, wherein the second modeling material formulation differs from the first modeling material formulation primarily (e.g., only) in that it further comprises an agent which promotes electroless metal deposition.

Herein throughout, a “curable material” is a compound (monomeric or oligomeric or polymeric compound) which, when exposed to a curing condition, as described herein, solidifies or hardens to form a cured modeling material as defined herein. Exposure to a curing condition may be, for example, exposure to a curing energy (as described herein) and/or to a chemical reagent. Curable materials are typically polymerizable materials, which undergo polymerization and/or cross-linking when exposed to suitable curing condition.

The polymerization can be, for example, free radical polymerization, cationic polymerization or anionic polymerization, and each can be induced when exposed to curing condition, such as a curing energy (e.g., radiation, heat, etc.), as described herein.

The terms “cure”, “solidify” and “harden” as used herein are interchangeable.

Curable materials may optionally comprise a mixture of different substances (e.g., which polymerize or undergo cross-linking upon curing to form a copolymeric material), or comprise a single curable substance (e.g., which polymerize or undergo cross-linking upon curing to form a homopolymeric material).

The first curable material (of the first modeling material formulation) and the second curable material (of the second modeling material formulation) may optionally be curable under the same curing conditions (e.g., when the first and second curable material are the same or chemically similar) or different curing conditions. Curability under the same curing conditions is preferred, in order to allow for a simpler curing process.

In some of any of the embodiments described herein, a curable material is a photopolymerizable material, which polymerizes or undergoes cross-linking upon exposure to radiation, as described herein, and in some embodiments the curable material is a UV-curable material, which polymerizes or undergoes cross-linking upon exposure to UV-visible radiation, as described herein.

In some embodiments, a curable material as described herein is a polymerizable material that polymerizes via photo-induced free radical polymerization.

In some of any of the embodiments described herein, a curable material can be a monomer, an oligomer or a short-chain polymer, each being polymerizable and/or cross-linkable as described herein.

In some of any of the embodiments described herein, when a curable material is exposed to curing energy (e.g., radiation), it polymerizes by any one, or by a combination, of chain elongation and cross-linking.

In some of any of the embodiments described herein, a curable material is a monomer or a mixture of monomers which can form a polymeric modeling material upon a polymerization reaction, when exposed to curing energy at which the polymerization reaction occurs. Such curable materials are also referred to herein as monomeric curable materials.

In some of any of the embodiments described herein, a curable material is an oligomer or a mixture of oligomers which can form a polymeric modeling material upon a polymerization reaction, when exposed to curing energy at which the polymerization reaction occurs. Such curable materials are also referred to herein as oligomeric curable materials.

In some of any of the embodiments described herein, a curable material is a polymer or a mixture of polymers which can form a polymeric or co-polymeric material upon a polymerization reaction, by chain extension or addition, or which cross-link, or is cross-linked by, other curable materials, when exposed to curing energy at which the polymerization reaction occurs. Such curable materials are also referred to herein as polymeric curable materials.

In some of any of the embodiments described herein, a curable material, whether monomeric or oligomeric or polymeric, can be a mono-functional curable material or a multi-functional curable material.

Herein, a mono-functional curable material comprises one functional group that can undergo polymerization when exposed to curing energy (e.g., radiation).

A multi-functional curable material comprises two or more, e.g., 2, 3, 4 or more, functional groups that can undergo polymerization when exposed to curing energy. Multi-functional curable materials can be, for example, di-functional, tri-functional or tetra-functional curable materials, which comprise 2, 3 or 4 groups that can undergo polymerization, respectively. The two or more functional groups in a multi-functional curable material are typically linked to one another by a linking moiety, as defined herein. When the linking moiety is an oligomeric moiety, the multi-functional group is an oligomeric multi-functional curable material.

Each of the curable materials can independently be a monomer, an oligomer or a polymer (which may undergo, for example, cross-linking, when cured).

Each of the curable materials can independently be a mono-functional or multi-functional material.

In some embodiments, a first curable material and/or second curable material comprises (and optionally consists essentially of) a (meth)acrylic material.

Herein throughout, the term “(meth)acrylic” encompasses acrylic and methacrylic materials. Acrylic and methacrylic materials encompass materials bearing one or more acrylate, methacrylate, acrylamide and/or methacrylamide group.

Non-limiting examples of suitable mono-functional (meth)acrylic materials include isobornyl acrylate (IBOA); isobornylmethacrylate; acryloyl morpholine (ACMO); phenoxyethyl acrylate, e.g., marketed by Sartomer Company (USA) under the tradename SR-339; and urethane acrylate oligomer, such as marketed under the name CN 131B.

Non-limiting examples of multi-functional (meth)acrylic materials include propoxylated (2) neopentyl glycol diacrylate, e.g., marketed by Sartomer Company (USA) under the tradename SR-9003; ditrimethylolpropane tetra-acrylate (DiTMPTTA); pentaerythritol tetra-acrylate (TETTA); dipentaerythritol penta-acrylate (DiPEP); and an aliphatic urethane diacrylate, e.g., such as marketed as Ebecryl® 230.

Additional non-limiting examples of multi-functional (meth)acrylic materials include oligomers such as ethoxylated or methoxylated polyethylene glycol diacrylate or dimethacrylate; ethoxylated bisphenol A diacrylate; polyethylene glycol-polyethylene glycol urethane diacrylate; a partially acrylated polyol oligomer; polyester-based urethane diacrylates such as marketed as CN991.

Non-limiting examples of curable materials and combinations thereof, which are suitable for use in formulation system described herein, include curable formulations marketed as the Vero™ family materials (or any curable material included therein), including e.g., Vero™ of any marketed color, VeroClear™ and VeroFlex™ formulations.

Vero™ family materials may optionally be used as the first modeling material formulation according to any of the respective embodiments described herein.

In some exemplary, non-limiting embodiments, the first formulation comprises, as curable materials, at least one hydrophilic curable material (e.g., ACMO), at least one hydrophobic curable material (e.g., IBOA), and at least one difunctional acrylate.

In some exemplary, non-limiting embodiments, the second formulation comprises, as curable materials, materials similar or even identical to those included in the first formulation.

Photoinitiator:

In some of any of the embodiments described herein, each of the first, second, and optionally other building material formulations independently comprises a photoinitiator, for initiating the polymerization or cross-linking (curing) upon exposure to curing energy (e.g., radiation).

In some embodiments, the photoinitiator is a free radical initiator.

A free radical photoinitiator may be any compound that produces a free radical on exposure to radiation such as ultraviolet or visible radiation and thereby initiates a polymerization reaction. Non-limiting examples of suitable photoinitiators include benzophenones (aromatic ketones) such as benzophenone, methyl benzophenone, Michler's ketone and xanthones; acylphosphine oxide type photoinitiators such as diphenyl(2,4,6-trimethylbenzoyl)phosphine oxide (TPO), 2,4,6-trimethylbenzoylethoxyphenyl phosphine oxide (TEPO), monoacyl phosphine oxides (MAPOs) and bisacylphosphine oxides (BAPOs); benzoins and benzoin alkyl ethers such as benzoin, benzoin methyl ether and benzoin isopropyl ether and the like. Examples of photoinitiators are alpha-amino ketone, alpha-hydroxy ketone (e.g., 1-hydroxy-cyclohexyl phenyl ketone), monoacyl phosphine oxides (MAPOs) and bisacylphosphine oxide (BAPOs), as well as those marketed under the tradename Irgacure®.

A free radical photoinitiator may be used alone or in combination with a co-initiator. Co-initiators are used with initiators that need a second molecule to produce a free radical that is active in the UV-systems. Benzophenone is an example of a photoinitiator that requires a second molecule, such as an amine, to produce a free radical which effectively initiates curing. After absorbing radiation, benzophenone reacts with a ternary amine by hydrogen abstraction, to generate an alpha-amino free radical which initiates polymerization of acrylates. Non-limiting example of a class of co-initiators are alkylamines such as triethylamine and alkanolamines (such as methyldiethanolamine and triethanolamine).

In some embodiments, a concentration of photoinitiator in the first and/or the second modeling material formulation independently ranges from 0.5 to 5%, or from 1 to 5%, or from 2 to 5%, by weight of the total weight of the respective formulation.

Alternatively or additionally, in some embodiments, a concentration of photoinitiator in the second modeling material formulation is greater than a concentration of photoinitiator in the first modeling material formulation, for example in some embodiments wherein the electroless deposition promoter (e.g., a solid electroless deposition promoter described herein such as a metal particle) interferes with light (e.g., by absorption and/or scattering) for effecting photo-induced reactions.

In some embodiments, a concentration of photoinitiator in the second modeling material formulation is at least 50% greater than (i.e., 1.5-fold) a concentration of photoinitiator in the first modeling material formulation. In some embodiments, a concentration of photoinitiator in the second modeling material formulation is at least twice a concentration of photoinitiator in the first modeling material formulation. In some embodiments, a concentration of photoinitiator in the second modeling material formulation is at least 3-fold a concentration of photoinitiator in the first modeling material formulation. In exemplary embodiments, a concentration of photoinitiator in the second modeling material formulation is about 3-fold a concentration of photoinitiator in the first modeling material formulation.

Electroless Deposition Promoter:

In some of any of the embodiments described herein, the electroless deposition promoter in the second modeling material formulation is a catalyst of electroless metal deposition (according to any of the respective embodiments described herein). In some such embodiments, the catalyst is a metal particle (e.g., nanoparticle). Silver nanoparticles are an exemplary electroless deposition promoter which is a catalyst.

Examples of suitable ranges for a concentration of catalyst of electroless metal deposition in a second modeling material formulation include, without limitation, from 1 to 10 weight percents, from 2 to 10 weight percents, from 3 to 10 weight percents, from 2 to 8 weight percents, from 3 to 7 weight percents, and from 4 to 6 weight percents, optionally about 5 weight percents.

As exemplified herein, gradual addition and/or dilution of catalyst particles to a desired concentration in a modeling material formulation may be useful in avoiding agglomeration and/or precipitation of the particles.

In some of any of the embodiments described herein, the electroless deposition promoter is a substance capable of binding to a catalyst of electroless metal deposition (according to any of the respective embodiments described herein relating to such a catalyst), e.g., a catalyst comprised by an activating substance. In some such embodiments, the electroless deposition promoter is acrylic acid or methacrylic acid.

Examples of suitable ranges for a concentration of electroless deposition promoter which binds to a catalyst of electroless metal deposition in a second modeling material formulation include, without limitation, from 1 to 90 weight percents, from 2 to 80 weight percents, from 3 to 70 weight percents, from 4 to 60 weight percents, and from 5 to 50 weight percents.

High concentrations (e.g., at least 5 weight percents, at least 10 weight percents) of such an electroless deposition promoter may be used, for example, when the electroless deposition promoter is a curable material (e.g., a curable material according to any of the respective embodiments described herein), such as a curable monomer or oligomer comprising a suitable functional group (e.g., carboxylic acid group) for binding a catalyst (e.g., acrylic acid, methacrylic acid, or oligomer thereof).

The electroless deposition promoter and concentration thereof in the second modeling material formulation are preferably selected to be suitable for an additive manufacturing process according to any of the respective embodiments described herein. For example, in embodiments wherein the electroless deposition promoter is a solid catalyst, a particle size of the catalyst is preferably selected so as not to be so large as to interfere with the manufacturing process (e.g., inkjet printing).

The catalyst of electroless metal deposition may be any suitable catalyst known in the art.

In some embodiments, the catalyst is a metal (in solid phase), for example, a noble metal. Silver and palladium are non-limiting examples of noble metals capable of catalyzing electroless metal deposition.

The metal in a catalyst (according to any of the respective embodiments described herein) may optionally be in a form of particles, e.g., to facilitate incorporation in a modeling material formulation and/or to increase catalytic surface area. In some embodiment, the particles comprise nanoparticles, for example, silver particles and/or palladium particles.

Without being bound by any particular theory, it is believed that a (solid) metal on a surface may catalyze electroless deposition on the surface by accepting electrons from a suitable reducing agent (e.g., as described herein) and transferring electrons to metal ions (in the vicinity of the surface), thereby inducing deposition of a metal (which may be the same as or different than the metal of the catalyst).

Herein, the term “nanoparticle” refers to a particle less than 1 micron in size. In addition, the plural “nanoparticles” herein encompasses populations of particles wherein the average particle size of the population is less than 1 micron.

In some embodiments, the nanoparticles have an average particle size in the range of from 0.1 nm to 900 nm, or from 0.1 nm to 700 nm, or from 1 nm to 700 nm, or from 10 nm to 700 nm, or from 10 nm to 500 nm, or from 20 nm to 500 nm or from 50 nm to 300 nm, or from 50 nm to 100 nm, including any intermediate value and subranges therebetween.

Without being bound by any particular theory, it is believed that small particles, such as nanoparticles, advantageously exhibit large surface area capable of effecting catalysis, and/or suitability for being included in a modeling material formulation (e.g., in any of the respective embodiments described herein) used in additive manufacturing (e.g., inkjet printing) without interfering with the additive manufacturing process.

Additional Components:

In some of any of the embodiments described herein, the first and/or second modeling material formulation independently further comprises one or more additional materials, which are referred to herein also as non-reactive materials (non-curable materials).

Such agents include, for example, surface active agents (surfactants), inhibitors, antioxidants, fillers, pigments, dyes, and/or dispersants.

Surface-active agents may be used to reduce the surface tension of the formulation to the value required for jetting or for printing process, which is typically around 30 dyne/cm. Such agents include silicone materials, for example, organic polysiloxanes such as PDMS and derivatives therefore, such as those commercially available as BYK type surfactants.

Surface-active agents may be included in the second modeling material formulation to facilitate inclusion of the electroless deposition promoter therein, for example, to enhance solubility of the electroless deposition promoter in the formulation and/or reduce the surface tension of the electroless deposition promoter in the formulation (e.g., reducing agglomeration of electroless deposition promoter particles). Determination of one or more suitable surfactants for a given electroless deposition promoter and given formulation components is well within the capabilities of a skilled person.

Suitable dispersants (dispersing agents) can also be silicone materials, for example, organic polysiloxanes such as PDMS and derivatives therefore, such as those commercially available as BYK type surfactants.

Suitable stabilizers (stabilizing agents) include, for example, thermal stabilizers, which stabilize the formulation at high temperatures.

The term “filler” describes an inert material that modifies the properties of a polymeric material and/or adjusts a quality of the end products. The filler may be an inorganic particle, for example calcium carbonate, silica, and clay.

Fillers may be added to the modeling formulation in order to reduce shrinkage during polymerization or during cooling, for example, to reduce the coefficient of thermal expansion, increase strength, increase thermal stability, reduce cost and/or adopt rheological properties. Nanoparticles fillers are typically useful in applications requiring low viscosity such as inkjet applications.

In some embodiments, a concentration of each of a surfactant and/or a dispersant and/or a stabilizer and/or a filler, if present, ranges from 0.01 to 2%, or from 0.01 to 1%, by weight, of the total weight of the respective formulation. Dispersants are typically used at a concentration that ranges from 0.01 to 0.1%, or from 0.01 to 0.05%, by weight, of the total weight of the respective formulation.

In some embodiments, the first and/or second modeling material formulation further comprises an inhibitor. The inhibitor is included for preventing or reducing curing before exposure to curing energy. Suitable inhibitors include, for example, those commercially available as the Genorad™ type, or as MEHQ. Any other suitable inhibitors are contemplated.

The pigments can be organic and/or inorganic and/or metallic pigments, and in some embodiments the pigments are nanoscale pigments, which include nanoparticles.

Exemplary inorganic pigments include nanoparticles of titanium oxide, and/or of zinc oxide and/or of silica. Exemplary organic pigments include nano-sized carbon black.

In some embodiments, the pigment's concentration ranges from 0.1 to 2% by weight, or from 0.1 to 1.5%, by weight, of the total weight of the respective formulation.

In some embodiments, combinations of white pigments and dyes are used to prepare colored cured materials.

The dye may be any of a broad class of solvent soluble dyes. Some non-limiting examples are azo dyes which are yellow, orange, brown and red; anthraquinone and triarylmethane dyes which are green and blue; and azine dye which is black.

In some embodiments, the first and/or second modeling material formulation comprises a pigment and/or dye, for example, to facilitate distinguishing between the formulations (e.g., in the obtained three-dimensional object) according to different colors.

Exemplary Formulations:

In some embodiments, a modeling material formulation (optionally a first modeling material formulation and/or a second modeling material formulation) as described herein, is characterized, when hardened, by a tensile strength of at least 2 MPa, optionally at least 5 MPa, optionally at least 10 MPa, optionally at least 20 MPa and optionally at least 40 MPa (and optionally no more than 200 MPa or 100 MPa). Exemplary modeling material formulations are characterized upon hardening by a tensile strength in a range of from about 50 MPa to about 65 MPa.

In some embodiments, a modeling material formulation (optionally a first modeling material formulation and/or a second modeling material formulation) as described herein, is characterized, when hardened, by an elongation at break in a range of from about 1% to 100%, and optionally from about 5% to 50%. Exemplary modeling material formulations are characterized upon hardening by an elongation at break in a range of from about 10% to about 25%. Elongation at break may be determined, for example, according to ASTM D-638-05.

In some embodiments, a modeling material formulation (optionally a first modeling material formulation and/or a second modeling material formulation) as described herein, is characterized, when hardened, by a modulus of elasticity of at least 200 MPa, optionally at least 500 MPa, optionally at least 1000 MPa, and optionally at least 2000 MPa (and optionally no more than 10000 MPa or 5000 MPa). Exemplary modeling material formulations are characterized upon hardening by a modulus of elasticity in a range of from about 2000 MPa to about 3000 MPa.

In some embodiments, a modeling material formulation (optionally a first modeling material formulation and/or a second modeling material formulation) as described herein, is characterized, when hardened, by a flexural strength of at least 5 MPa, optionally at least 10 MPa, optionally at least 25 MPa, optionally at least 50 MPa, and optionally at least 75 MPa (and optionally no more than 400 MPa or 200 MPa). Exemplary modeling material formulations are characterized upon hardening by a flexural strength in a range of from about 75 MPa to about 110 MPa.

In some embodiments, a modeling material formulation (optionally a first modeling material formulation and/or a second modeling material formulation) as described herein, is characterized, when hardened, by a flexural modulus of at least 200 MPa, optionally at least 500 MPa, optionally at least 1000 MPa, and optionally at least 2000 MPa (and optionally no more than 10000 MPa or 5000 MPa). Exemplary modeling material formulations are characterized upon hardening by a flexural modulus in a range of from about 2200 MPa to about 3200 MPa.

In some embodiments, a modeling material formulation (optionally a first modeling material formulation and/or a second modeling material formulation) as described herein, is characterized, when hardened, by an HDT at 0.45 MPa and/or 1.82 MPa of at least 30° C., and optionally at least 40° C. (optionally no more than 200° C. or 100° C.). Exemplary modeling material formulations are characterized upon hardening by an HDT at 0.45 MPa and 1.82 MPa in a range of from about 45° C. to about 50° C.

As used herein, “HDT” refers to a temperature at which the respective material deforms under a predetermined load at some certain temperature. Suitable test procedures for determining the HDT of a material are the ASTM D-648 series, particularly the ASTM D-648-06 and ASTM D-648-07 methods. In some embodiments, HDT is determined at a pressure of 0.45 MPa (e.g., ASTM D-648-06) or at 1.82 MPa (e.g., ASTM D-648-06).

In some embodiments, a modeling material formulation (optionally a first modeling material formulation and/or a second modeling material formulation) as described herein, is characterized, when hardened, by a Tg of at least 30° C., optionally at least 40° C. and optionally at least 50° C. (optionally no more than 200° C. or 100° C.). Exemplary modeling material formulations are characterized upon hardening by a Tg in a range of from about 52° C. to about 54° C.

Herein, “Tg” refers to glass transition temperature defined as the location of the local maximum of an E″ curve, where E″ is the loss modulus of the material as a function of the temperature. Broadly speaking, as the temperature is raised within a range of temperatures containing the Tg, the state of a material, particularly a polymeric material, gradually changes from a glassy state into a rubbery state.

Herein, “Tg range” is a temperature range at which the E″ value is at least half (e.g., from 50% to 100% of) the E″ value at the Tg temperature as defined above.

Without wishing to be bound to any particular theory, it is assumed that the state of a polymeric material gradually changes from the glassy state into the rubbery within the Tg range as defined above. Herein, the term “Tg” refers to any temperature within the Tg range as defined herein.

As used herein and in the art, storage modulus (E′) is defined according to ISO 6721-1, as representing a stiffness of a material as measured in dynamic mechanical analysis, and is proportional to the energy stored in a specimen during a loading cycle. In some embodiments, the storage modulus is determined as described in the Examples section that follows. In some embodiments, the storage modulus is determined according to ASTM D4605.

By “flexural strength” it is meant the stress in a material just before it yields in a flexure test. Flexural strength may be determined, for example, according to ASTM D-790-03.

By “flexural modulus” it is meant the ratio of stress to strain in flexural deformation, which is determined from the slope of a stress-strain curve produced by a flexural test such as the ASTM D790. Flexural modulus may be determined, for example, according to ASTM D-790-04.

By “tensile strength” it is meant the maximum stress that a material can withstand while being stretched or pulled before breaking. Tensile strength may be determined, for example, according to ASTM D-638-03.

The skilled person will be readily capable of selecting suitable concentrations (and types) of curable material, for arriving at properties (upon curing) according to any of the respective embodiments described herein.

Kits:

According to an aspect of some embodiments of the invention, there is provided a kit for use in additive manufacturing, the kit comprising a modeling material formulation(s) or a formulation system, as described herein in any of the respective embodiments and any combination thereof.

In some of any of the embodiments described herein relating to a kit, the kit comprises a modeling material formulation which comprises a curable material and an agent which promotes electroless metal deposition (e.g., according to any of the embodiments herein relating to such a curable material, agent and/or formulation, such as a second modeling material formulation described herein). In some embodiments, the kit further comprises a modeling material formulation which does not comprise an agent which promotes electroless metal deposition (e.g., according to any of the embodiments herein relating to such a formulation, such as a first modeling material formulation described herein).

In some embodiments, the first modeling material formulation and second modeling material formulation are each packaged individually in the kit. In some embodiments wherein one or more additional building material formulations are included in the kit (e.g., supporting material formulation(s)), each formulation is packaged individually in the kit.

In exemplary embodiments, each of the formulation(s) is packaged within the kit in a suitable packaging material, preferably, an impermeable material (e.g., water- and gas-impermeable material), and further preferably an opaque material. In some embodiments, the kit further comprises instructions to use the formulations in an additive manufacturing process, preferably a 3D inkjet printing process as described herein. The kit may further comprise instructions to use the formulations in the process in accordance with the method as described herein.

In some embodiments, all the components of each formulation are packaged together. In some of these embodiments, the formulations are packaged in a packaging material which protects the formulations from exposure to light or any other radiation and/or comprise an inhibitor.

In some embodiments, the photoinitiator is packaged separately from other components of each formulation, and the kit optionally comprises instructions to add the initiator to the respective formulation (e.g., at a concentration described herein) according to any of the respective embodiments described herein.

In some of any of the respective embodiments described herein, the kit further comprises an activating substance (e.g., silver particles and/or a substance comprising Pd(II)), according to any of the respective embodiments described herein, capable of activating an electroless deposition promoter in the kit. The activating substance is optionally packaged separately within the kit.

In some embodiments, the kit includes instructions for using the activating substance to activate an electroless deposition promoter (according to any of the respective embodiments described herein).

In some of any of the respective embodiments described herein, the kit further comprises an electroless deposition solution, according to any of the respective embodiments described herein, capable of forming an electrically-conductive material in the presence of an electroless deposition promoter in the kit. The electroless deposition solution is optionally packaged separately within the kit.

In some embodiments, the kit includes instructions for using the electroless deposition solution to form an electrically-conducting material according to a method described herein (according to any of the respective embodiments).

Additive Manufacturing System:

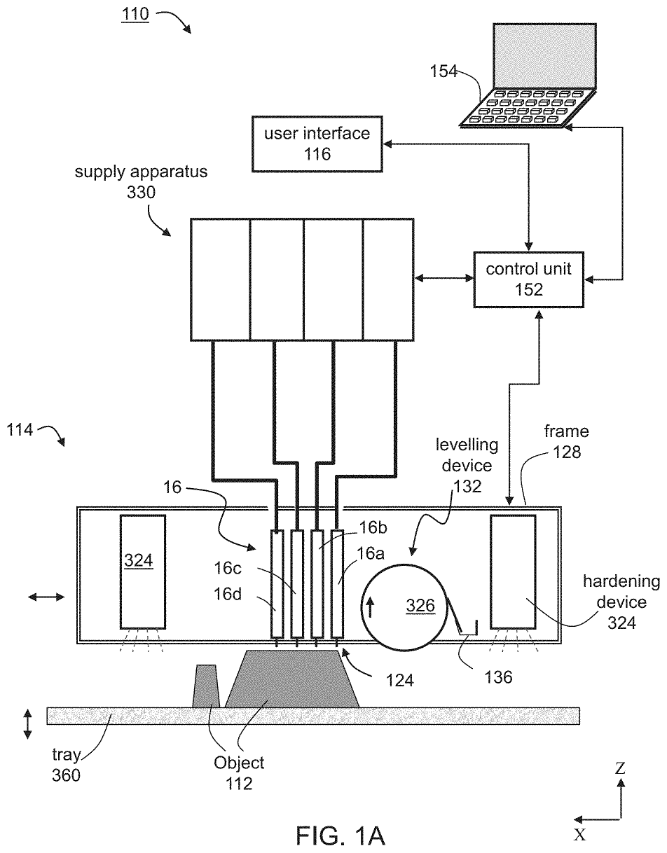

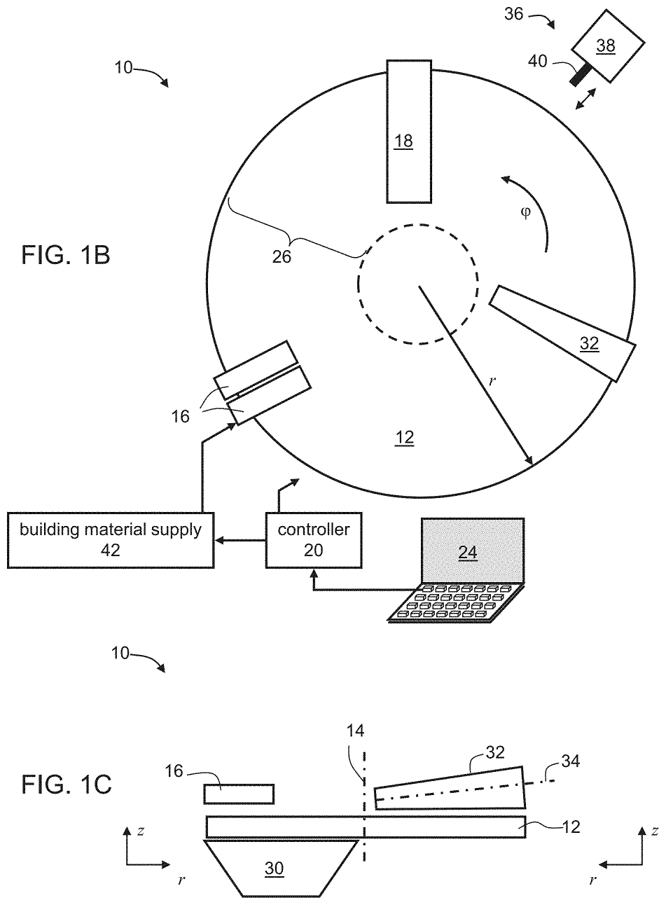

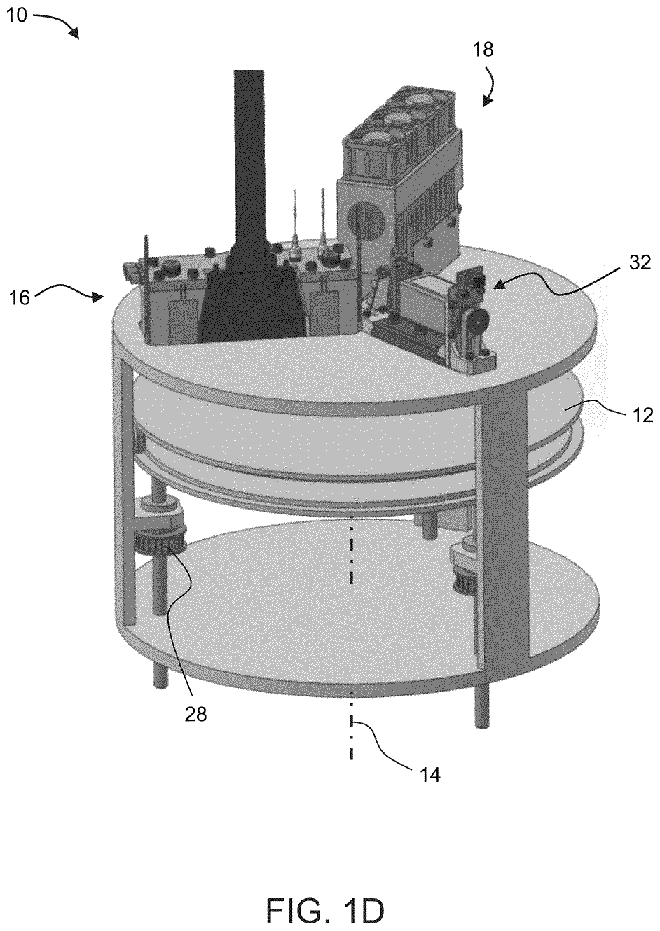

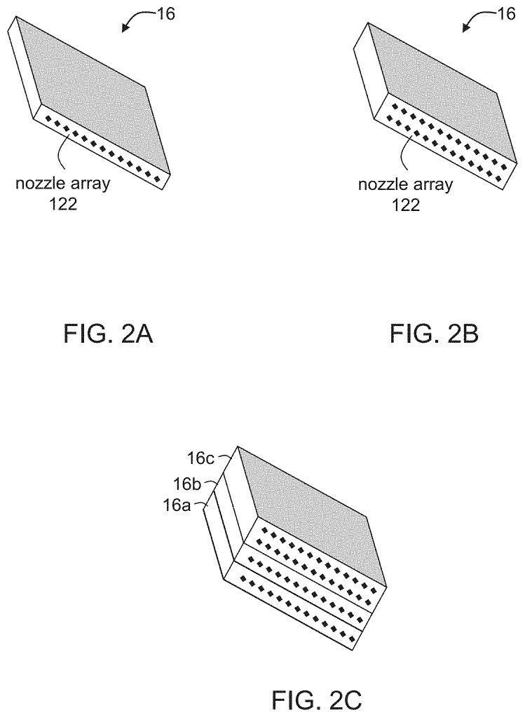

A representative and non-limiting example of a system 110 suitable for additive manufacturing (AM) of an object 112 according to some embodiments of the present invention is illustrated in FIG. 1A. System 110 comprises an additive manufacturing apparatus 114 having a dispensing unit 16 which comprises a plurality of dispensing heads (e.g., printing heads). Each head preferably comprises one or more arrays of nozzles 122, as illustrated in FIGS. 2A-C described below, through which a liquid (uncured) building material formulation 124 is dispensed.

Preferably, but not obligatorily, apparatus 114 is a three-dimensional printing apparatus, in which case the dispensing heads are printing heads (e.g., inkjet printing heads), and the building material formulation is dispensed via inkjet technology. This need not necessarily be the case, since, for some applications, it may not be necessary for the additive manufacturing apparatus to employ three-dimensional printing techniques. Representative examples of additive manufacturing apparatus contemplated according to various exemplary embodiments of the present invention include, without limitation, fused deposition modeling apparatus and fused material formulation deposition apparatus.

The term “printing head” as used herein represents a dispensing head usable in 3D printing such as 3D inkjet printing.

Whenever “dispensing head” is indicated, it encompasses “printing head”.

Each dispensing head is optionally and preferably fed via a building material formulation reservoir which may optionally include a temperature control unit (e.g., a temperature sensor and/or a heating device), and a material formulation level sensor. To dispense the building material formulation, a voltage signal is applied to the dispensing heads to selectively deposit droplets of a material formulation via the dispensing (e.g., printing) head nozzles, for example, as in piezoelectric inkjet printing technology. The dispensing rate of each head depends on the number of nozzles, the type of nozzles and the applied voltage signal rate (frequency). Such dispensing heads are known to those skilled in the art of solid freeform fabrication.

Preferably, but not obligatorily, the overall number of dispensing nozzles or nozzle arrays is selected such that half of the dispensing nozzles are designated to dispense support material formulation and half of the dispensing nozzles are designated to dispense modeling material formulation, i.e., the number of nozzles jetting modeling material formulations is the same as the number of nozzles jetting support material formulation. In the representative example of FIG. 1A, four dispensing heads 16a, 16b, 16c and 16d are illustrated. Each of heads 16a, 16b, 16c and 16d has a nozzle array. In this Example, heads 16a and 16b can be designated for modeling material formulation/s and heads 16c and 16d can be designated for support material formulation. Thus, head 16a can dispense a first modeling material formulation, head 16b can dispense a second modeling material formulation and heads 16c and 16d can both dispense support material formulation. In an alternative embodiment, heads 16c and 16d, for example, may be combined in a single head having two nozzle arrays for depositing support material formulation. In a further alternative embodiment any one or more of the printing heads may have more than one nozzle arrays for depositing more than one material formulation, e.g. two nozzle arrays for depositing two different modeling material formulations or a modeling material formulation and a support material formulation, each formulation via a different array or number of nozzles. In a further alternative embodiment any one or more of the printing heads may have more than one nozzle arrays for depositing more than one material formulation, e.g. two nozzle arrays for depositing two different modeling material formulations or a modeling material formulation and a support material formulation, each formulation via a different array or number of nozzles.

Yet it is to be understood that it is not intended to limit the scope of the present invention and that the number of modeling material formulation depositing heads (modeling heads) and the number of support material formulation depositing heads (support heads) may differ. Generally, Generally, the number of arrays of nozzles that dispense modeling material formulation, the number of arrays of nozzles that dispense support material formulation, and the number of nozzles in each respective array are selected such as to provide a predetermined ratio, a, between the maximal dispensing rate of the support material formulation and the maximal dispensing rate of modeling material formulation. The value of the predetermined ratio, a, is preferably selected to ensure that in each formed layer, the height of modeling material formulation equals the height of support material formulation. Typical values for a are from about 0.6 to about 1.5.

For example, for a=1, the overall dispensing rate of support material formulation is generally the same as the overall dispensing rate of the modeling material formulation when all the arrays of nozzles operate.

For example, apparatus 114 can comprise M modeling heads each having m arrays of p nozzles, and S support heads each having s arrays of q nozzles such that M×m×p=S×sx×q. Each of the Mxm modeling arrays and S×s support arrays can be manufactured as a separate physical unit, which can be assembled and disassembled from the group of arrays. In this embodiment, each such array optionally and preferably comprises a temperature control unit and a material formulation level sensor of its own, and receives an individually controlled voltage for its operation.

The terms “print head”, “printhead” and “printing head” are used herein interchangeably, and represent a dispensing head usable in 3D printing such as 3D inkjet printing.

Apparatus 114 can further comprise a solidifying device 324 which can include any device configured to emit light, heat or the like that may cause the deposited material formulation to harden. For example, solidifying device 324 can comprise one or more radiation sources, which can be, for example, an ultraviolet or visible or infrared lamp, or other sources of electromagnetic radiation, or electron beam source, depending on the modeling material formulation being used. In some embodiments of the present invention, solidifying device 324 serves for curing or solidifying the modeling material formulation.

In some embodiments of the present invention apparatus 114 comprises cooling system 134 such as one or more fans or the like.

The dispensing (e.g., printing) head and radiation source are preferably mounted in a frame or block 128 which is preferably operative to reciprocally move over a tray 360, which serves as the working surface. In some embodiments of the present invention the radiation sources are mounted in the block such that they follow in the wake of the dispensing heads to at least partially cure or solidify the material formulations just dispensed by the dispensing heads. Tray 360 is positioned horizontally. According to the common conventions an X-Y-Z Cartesian coordinate system is selected such that the X-Y plane is parallel to tray 360. Tray 360 is preferably configured to move vertically (along the Z direction), typically downward. In various exemplary embodiments of the invention, apparatus 114 further comprises one or more leveling devices 132, e.g., a roller 326. Leveling device 326 serves to straighten, level and/or establish a thickness of the newly formed layer prior to the formation of the successive layer thereon. Leveling device 326 preferably comprises a waste collection device 136 for collecting the excess material formulation generated during leveling. Waste collection device 136 may comprise any mechanism that delivers the material formulation to a waste tank or waste cartridge.

In use, the dispensing heads of unit 16 move in a scanning direction, which is referred to herein as the X direction, and selectively dispense building material formulation in a predetermined configuration in the course of their passage over tray 360. The building material formulation typically comprises one or more types of support material formulation and one or more types of modeling material formulation. The passage of the dispensing heads of unit 16 is followed by the curing of the modeling material formulation(s) by radiation source 126. In the reverse passage of the heads, back to their starting point for the layer just deposited, an additional dispensing of building material formulation may be carried out, according to predetermined configuration. In the forward and/or reverse passages of the dispensing heads, the layer thus formed may be straightened by leveling device 326, which preferably follows the path of the dispensing heads in their forward and/or reverse movement. Once the dispensing heads return to their starting point along the X direction, they may move to another position along an indexing direction, referred to herein as the Y direction, and continue to build the same layer by reciprocal movement along the X direction. Alternately, the dispensing heads may move in the Y direction between forward and reverse movements or after more than one forward-reverse movement. The series of scans performed by the dispensing heads to complete a single layer is referred to herein as a single scan cycle.

Once the layer is completed, tray 360 is lowered in the Z direction to a predetermined Z level, according to the desired thickness of the layer subsequently to be printed. The procedure is repeated to form three-dimensional object 112 in a layerwise manner.

In another embodiment, tray 360 may be displaced in the Z direction between forward and reverse passages of the dispensing head of unit 16, within the layer. Such Z displacement is carried out in order to cause contact of the leveling device with the surface in one direction and prevent contact in the other direction.

System 110 optionally and preferably comprises a building material formulation supply system 330 which comprises the building material formulation containers or cartridges and supplies a plurality of building material formulations to fabrication apparatus 114.

A control unit 152 controls fabrication apparatus 114 and optionally and preferably also controls supply system 330. Control unit 152 typically includes an electronic circuit configured to perform the controlling operations. Control unit 152 preferably communicates with a data processor 154 which transmits digital data pertaining to fabrication instructions based on computer object data, e.g., a CAD configuration represented on a computer readable medium in a form of a Standard Tessellation Language (STL) format or the like. Typically, control unit 152 controls the voltage applied to each dispensing head or each nozzle array and the temperature of the building material formulation in the respective printing head or respective nozzle array.

Once the manufacturing data is loaded to control unit 152 it can operate without user intervention. In some embodiments, control unit 152 receives additional input from the operator, e.g., using data processor 154 or using a user interface 116 communicating with unit 152. User interface 116 can be of any type known in the art, such as, but not limited to, a keyboard, a touch screen and the like. For example, control unit 152 can receive, as additional input, one or more building material formulation types and/or attributes, such as, but not limited to, color, characteristic distortion and/or transition temperature, viscosity, electrical property, magnetic property. Other attributes and groups of attributes are also contemplated.

Another representative and non-limiting example of a system 10 suitable for AM of an object according to some embodiments of the present invention is illustrated in FIGS. 1B-D. FIGS. 1B-D illustrate a top view (FIG. 1B), a side view (FIG. 1C) and an isometric view (FIG. 1D) of system 10.

In the present embodiments, system 10 comprises a tray 12 and a plurality of inkjet printing heads 16, each having one or more arrays of nozzles with respective one or more pluralities of separated nozzles. Tray 12 can have a shape of a disk or it can be annular. Non-round shapes are also contemplated, provided they can be rotated about a vertical axis.

Tray 12 and heads 16 are optionally and preferably mounted such as to allow a relative rotary motion between tray 12 and heads 16. This can be achieved by (i) configuring tray 12 to rotate about a vertical axis 14 relative to heads 16, (ii) configuring heads 16 to rotate about vertical axis 14 relative to tray 12, or (iii) configuring both tray 12 and heads 16 to rotate about vertical axis 14 but at different rotation velocities (e.g., rotation at opposite direction). While the embodiments below are described with a particular emphasis to configuration (i) wherein the tray is a rotary tray that is configured to rotate about vertical axis 14 relative to heads 16, it is to be understood that the present application contemplates also configurations (ii) and (iii). Any one of the embodiments described herein can be adjusted to be applicable to any of configurations (ii) and (iii), and one of ordinary skills in the art, provided with the details described herein, would know how to make such adjustment.

In the following description, a direction parallel to tray 12 and pointing outwardly from axis 14 is referred to as the radial direction r, a direction parallel to tray 12 and perpendicular to the radial direction r is referred to herein as the azimuthal direction φ, and a direction perpendicular to tray 12 is referred to herein is the vertical direction z.

The term “radial position,” as used herein, refers to a position on or above tray 12 at a specific distance from axis 14. When the term is used in connection to a printing head, the term refers to a position of the head which is at specific distance from axis 14. When the term is used in connection to a point on tray 12, the term corresponds to any point that belongs to a locus of points that is a circle whose radius is the specific distance from axis 14 and whose center is at axis 14.

The term “azimuthal position,” as used herein, refers to a position on or above tray 12 at a specific azimuthal angle relative to a predetermined reference point. Thus, radial position refers to any point that belongs to a locus of points that is a straight line forming the specific azimuthal angle relative to the reference point.

The term “vertical position,” as used herein, refers to a position over a plane that intersects the vertical axis 14 at a specific point.

Tray 12 serves as a supporting structure for three-dimensional printing. The working area on which one or objects are printed is typically, but not necessarily, smaller than the total area of tray 12. In some embodiments of the present invention the working area is annular. The working area is shown at 26. In some embodiments of the present invention tray 12 rotates continuously in the same direction throughout the formation of object, and in some embodiments of the present invention tray reverses the direction of rotation at least once (e.g., in an oscillatory manner) during the formation of the object. Tray 12 is optionally and preferably removable. Removing tray 12 can be for maintenance of system 10, or, if desired, for replacing the tray before printing a new object. In some embodiments of the present invention system 10 is provided with one or more different replacement trays (e.g., a kit of replacement trays), wherein two or more trays are designated for different types of objects (e.g., different weights) different operation modes (e.g., different rotation speeds), etc. The replacement of tray 12 can be manual or automatic, as desired. When automatic replacement is employed, system 10 comprises a tray replacement device 36 configured for removing tray 12 from its position below heads 16 and replacing it by a replacement tray (not shown). In the representative illustration of FIG. 1B tray replacement device 36 is illustrated as a drive 38 with a movable arm 40 configured to pull tray 12, but other types of tray replacement devices are also contemplated.

Exemplified embodiments for the printing head 16 are illustrated in FIGS. 2A-2C. These embodiments can be employed for any of the AM systems described above, including, without limitation, system 110 and system 10.

FIGS. 2A-B illustrate a printing head 16 with one (FIG. 2A) and two (FIG. 2B) nozzle arrays 22. The nozzles in the array are preferably aligned linearly, along a straight line. In embodiments in which a particular printing head has two or more linear nozzle arrays, the nozzle arrays are optionally and preferably can be parallel to each other. When a printing head has two or more arrays of nozzles (e.g., FIG. 2B) all arrays of the head can be fed with the same building material formulation, or at least two arrays of the same head can be fed with different building material formulations.

When a system similar to system 110 is employed, all printing heads 16 are optionally and preferably oriented along the indexing direction with their positions along the scanning direction being offset to one another.

When a system similar to system 10 is employed, all printing heads 16 are optionally and preferably oriented radially (parallel to the radial direction) with their azimuthal positions being offset to one another. Thus, in these embodiments, the nozzle arrays of different printing heads are not parallel to each other but are rather at an angle to each other, which angle being approximately equal to the azimuthal offset between the respective heads. For example, one head can be oriented radially and positioned at azimuthal position (pi, and another head can be oriented radially and positioned at azimuthal position φ₂. In this example, the azimuthal offset between the two heads is φ₁-φ₂, and the angle between the linear nozzle arrays of the two heads is also φ₁-φ₂.

In some embodiments, two or more printing heads can be assembled to a block of printing heads, in which case the printing heads of the block are typically parallel to each other. A block including several inkjet printing heads 16a, 16b, 16c is illustrated in FIG. 2C.

In some embodiments, system 10 comprises a support structure 30 positioned below heads 16 such that tray 12 is between support structure 30 and heads 16. Support structure 30 may serve for preventing or reducing vibrations of tray 12 that may occur while inkjet printing heads 16 operate. In configurations in which printing heads 16 rotate about axis 14, support structure 30 preferably also rotates such that support structure 30 is always directly below heads 16 (with tray 12 between heads 16 and tray 12).

Tray 12 and/or printing heads 16 is optionally and preferably configured to move along the vertical direction z, parallel to vertical axis 14 so as to vary the vertical distance between tray 12 and printing heads 16. In configurations in which the vertical distance is varied by moving tray 12 along the vertical direction, support structure 30 preferably also moves vertically together with tray 12. In configurations in which the vertical distance is varied by heads 16 along the vertical direction, while maintaining the vertical position of tray 12 fixed, support structure 30 is also maintained at a fixed vertical position.

The vertical motion can be established by a vertical drive 28. Once a layer is completed, the vertical distance between tray 12 and heads 16 can be increased (e.g., tray 12 is lowered relative to heads 16) by a predetermined vertical step, according to the desired thickness of the layer subsequently to be printed. The procedure is repeated to form a three-dimensional object in a layerwise manner.

The operation of dispensing (e.g., inkjet printing) heads 16 and optionally and preferably also of one or more other components of system 10, e.g., the motion of tray 12, are controlled by a controller 20. The controller can have an electronic circuit and a non-volatile memory medium readable by the circuit, wherein the memory medium stores program instructions which, when read by the circuit, cause the circuit to perform control operations as further detailed below.

Controller 20 can also communicate with a host computer 24 which transmits digital data pertaining to fabrication instructions based on computer object data, e.g., in a form of a Standard Tessellation Language (STL) or a StereoLithography Contour (SLC) format, Virtual Reality Modeling Language (VRML), Additive Manufacturing File (AMF) format, Drawing Exchange Format (DXF), Polygon File Format (PLY) or any other format suitable for Computer-Aided Design (CAD). The object data formats are typically structured according to a Cartesian system of coordinates. In these cases, computer 24 preferably executes a procedure for transforming the coordinates of each slice in the computer object data from a Cartesian system of coordinates into a polar system of coordinates. Computer 24 optionally and preferably transmits the fabrication instructions in terms of the transformed system of coordinates. Alternatively, computer 24 can transmit the fabrication instructions in terms of the original system of coordinates as provided by the computer object data, in which case the transformation of coordinates is executed by the circuit of controller 20.

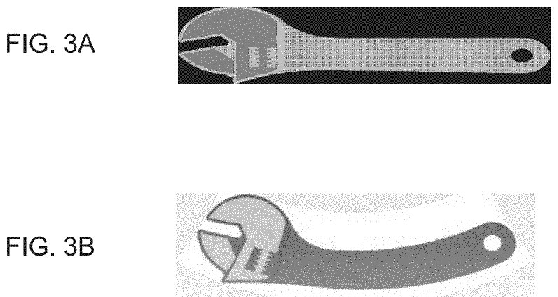

The transformation of coordinates allows three-dimensional printing over a rotating tray. In non-rotary systems with a stationary tray with the printing heads typically reciprocally move above the stationary tray along straight lines. In such systems, the printing resolution is the same at any point over the tray, provided the dispensing rates of the heads are uniform. In system 10, unlike non-rotary systems, not all the nozzles of the head points cover the same distance over tray 12 during at the same time. The transformation of coordinates is optionally and preferably executed so as to ensure equal amounts of excess material formulation at different radial positions. Representative examples of coordinate transformations according to some embodiments of the present invention are provided in FIGS. 3A-B, showing three slices of an object (each slice corresponds to fabrication instructions of a different layer of the objects), where FIG. 3A illustrates a slice in a Cartesian system of coordinates and FIG. 3B illustrates the same slice following an application of a transformation of coordinates procedure to the respective slice.

Typically, controller 20 controls the voltage applied to the respective component of the system 10 based on the fabrication instructions and based on the stored program instructions as described below.

Generally, controller 20 controls printing heads 16 to dispense, during the rotation of tray 12, droplets of building material formulation in layers, such as to print a three-dimensional object on tray 12.

System 10 optionally and preferably comprises one or more radiation sources 18, which can be, for example, an ultraviolet or visible or infrared lamp, or other sources of electromagnetic radiation, or electron beam source, depending on the modeling material formulation being used. Radiation source can include any type of radiation emitting device, including, without limitation, light emitting diode (LED), digital light processing (DLP) system, resistive lamp and the like. Radiation source 18 serves for curing or solidifying the modeling material formulation. In various exemplary embodiments of the invention the operation of radiation source 18 is controlled by controller 20 which may activate and deactivate radiation source 18 and may optionally also control the amount of radiation generated by radiation source 18.

In some embodiments of the invention, system 10 further comprises one or more leveling devices 32 which can be manufactured as a roller or a blade. Leveling device 32 serves to straighten the newly formed layer prior to the formation of the successive layer thereon. In some embodiments, leveling device 32 has the shape of a conical roller positioned such that its symmetry axis 34 is tilted relative to the surface of tray 12 and its surface is parallel to the surface of the tray. This embodiment is illustrated in the side view of system 10 (FIG. 1C).

The conical roller can have the shape of a cone or a conical frustum.

The opening angle of the conical roller is preferably selected such that is a constant ratio between the radius of the cone at any location along its axis 34 and the distance between that location and axis 14. This embodiment allows roller 32 to efficiently level the layers, since while the roller rotates, any point p on the surface of the roller has a linear velocity which is proportional (e.g., the same) to the linear velocity of the tray at a point vertically beneath point p. In some embodiments, the roller has a shape of a conical frustum having a height h, a radius R₁ at its closest distance from axis 14, and a radius R₂ at its farthest distance from axis 14, wherein the parameters h, R₁ and R₂ satisfy the relation R₁/R₂, (R−h)/h and wherein R is the farthest distance of the roller from axis 14 (for example, R can be the radius of tray 12).

The operation of leveling device 32 is optionally and preferably controlled by controller 20 which may activate and deactivate leveling device 32 and may optionally also control its position along a vertical direction (parallel to axis 14) and/or a radial direction (parallel to tray 12) and pointing toward or away from axis 14.

In some embodiments of the present invention dispensing (e.g., printing) heads 16 are configured to reciprocally move relative to tray along the radial direction r. These embodiments are useful when the lengths of the nozzle arrays 22 of heads 16 are shorter than the width along the radial direction of the working area 26 on tray 12. The motion of heads 16 along the radial direction is optionally and preferably controlled by controller 20.

In some of any of the embodiments described herein, the additive manufacturing is 3D inkjet printing and the system is a 3D inkjet printing system as described herein.

Some embodiments contemplate the fabrication of an object by dispensing different material formulations from different dispensing heads or from different arrays of nozzles (belonging to the same or different printing head). For example, the fabrication comprises dispensing a first formulation from a first array of nozzles, and dispensing a second formulation from a second array of nozzles. In some embodiments, the first and the second arrays of nozzles are of the same printing head. In some embodiments, the first and the second arrays of nozzles are of separate printing heads. In some of these embodiments, the first and second formulations are different modeling material formulations that form a formulation system as described herein.

These embodiments provide, inter alia, the ability to select material formulations from a given number of material formulations and define desired combinations of the selected material formulations and their properties. According to the present embodiments, the spatial locations of the deposition of each material formulation with the layer is defined, either to effect occupation of different three-dimensional spatial locations by different material formulations, or to effect occupation of substantially the same three-dimensional location or adjacent three-dimensional locations by two or more different material formulations so as to allow post deposition spatial combination of the material formulations within the layer, thereby to form a composite material formulation at the respective location or locations.

Any post deposition combination or mix of modeling material formulations is contemplated. For example, once a certain material formulation is dispensed it may preserve its original properties. However, when it is dispensed simultaneously with another modeling material formulation or other dispensed material formulations which are dispensed at the same or nearby locations, a composite material formulation having a different property or properties to the dispensed material formulations is formed.

The present embodiments thus enable the deposition of a broad range of material formulation combinations, and the fabrication of an object which may consist of multiple different combinations of material formulations, in different parts of the object, according to the properties desired to characterize each part of the object.

Further details on the principles and operations of an AM system suitable for the present embodiments are found in U.S. Published Application No. 20100191360, the contents of which are hereby incorporated by reference.

Additive Manufacturing Method:

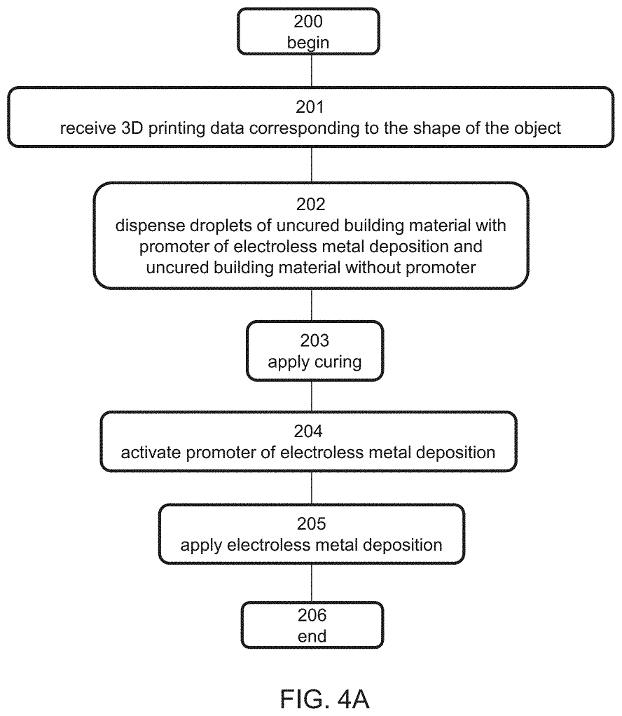

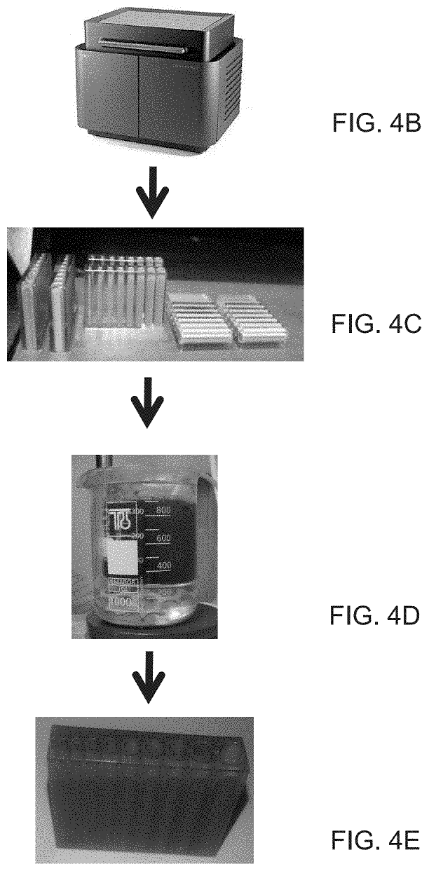

FIG. 4A presents a flowchart describing an exemplary method according to some embodiments of the present invention.

It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

Computer programs implementing the additive manufacturing (AM) method of the present embodiments can commonly be distributed to users on a distribution medium such as, but not limited to, a floppy disk, a CD-ROM, a flash memory device and a portable hard drive. From the distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with the method of this invention. All these operations are well-known to those skilled in the art of computer systems.

The computer implemented method of the present embodiments can be embodied in many forms. For example, it can be embodied in on a tangible medium such as a computer for performing the method operations. It can be embodied on a computer readable medium, comprising computer readable instructions for carrying out the method operations. In can also be embodied in electronic device having digital computer capabilities arranged to run the computer program on the tangible medium or execute the instruction on a computer readable medium.

The method begins at 200 and optionally and preferably continues to 201 at which computer object data (e.g., 3D printing data) corresponding to the shape of the object are received. The data can be received, for example, from a host computer which transmits digital data pertaining to fabrication instructions based on computer object data, e.g., in a form of STL, SLC format, VRML, AMF format, DXF, PLY or any other format suitable for CAD.

The method continues to 202 at which droplets of the uncured building material as described herein (e.g., two or more modeling material formulations as described herein, wherein at least one comprises an electroless deposition promoter and at least one does not, and optionally a support material formulation) are dispensed in layers, on a receiving medium, optionally and preferably using an AM system, such as, but not limited to, system 110 or system 10, according to the computer object data (e.g., printing data), and as described herein. In some embodiments, the AM system is a 3D inkjet printing system, e.g., as described herein. In any of the embodiments described herein the dispensing 202 is by at least two different multi-nozzle inkjet printing heads and/or by at least two different nozzle arrays. The receiving medium can be a tray of an AM system (e.g., tray 360 or 12) as described herein or a previously deposited layer.

In some exemplary embodiments of the invention an object is manufactured by dispensing a building material (uncured) that comprises two or more different modeling material formulations, each modeling material formulation from a different array of nozzles of the AM apparatus. In some embodiments, two or more such arrays of nozzles that dispense different modeling material formulations are both located in the same printing head of the AM apparatus. In some embodiments, arrays of nozzles that dispense different modeling material formulations are located in separate printing heads, for example, a first array of nozzles dispensing a first modeling material formulation is located in a first printing head, and a second array of nozzles dispensing a second modeling material formulation is located in a second printing head.

In some embodiments, an array of nozzles that dispense a modeling material formulation and an array of nozzles that dispense a support material formulation are both located in the same printing head. In some embodiments, an array of nozzles that dispense a modeling material formulation and an array of nozzles that dispense a support material formulation are both located in separate the same printing head.

The modeling material formulations are optionally and preferably deposited in layers during the same pass of the respective printing head(s). The modeling material formulations and combination of modeling material formulations within the layer are selected according to the desired properties of the object.

In some embodiments of the present invention, a support material formulation is dispensed adjacent to the second modeling material formulation comprising an electroless deposition promoter, e.g., wherein a surface of the support material is in contact with a surface of the second modeling material formulation. In some embodiments, a mixed layer (comprising the support material formulation and the second modeling material formulation in admixture) is formed upon contact of the support material formulation and the second modeling material formulation, e.g., where the surfaces of the two formulations meet.

As exemplified herein, in some embodiments (e.g., in which activation of an electroless deposition promoter is to be effected using palladium and/or no chemical etchant is used), a mixed layer at a surface may enhance efficacy of the electroless deposition promoter, upon removal of at least a portion of the support material formulation.

Support material formulation may optionally be dispensed adjacent to other modeling material formulations, for example, in order to control an appearance and/or reflectivity of a surface, as described herein below.

In some embodiments of the present invention, the dispensing 202 is effected under ambient environment.

Optionally, before being dispensed, the uncured building material, or a part thereof (e.g., one or more formulations of the building material), is heated, prior to being dispensed. These embodiments are particularly useful for uncured building material formulations having relatively high viscosity at the operation temperature of the working chamber of a 3D inkjet printing system. The heating of the formulation(s) is preferably to a temperature that allows jetting the respective formulation through a nozzle of a printing head of a 3D inkjet printing system. In some embodiments of the present invention, the heating is to a temperature at which the respective formulation exhibits a viscosity as described herein in any of the respective embodiments.

The heating can be executed before loading the respective formulation into the printing head of the AM (e.g., 3D inkjet printing) system, or while the formulation is in the printing head or while the composition passes through the nozzle of the printing head.

In some embodiments, the heating is executed before loading of the respective formulation into the dispensing (e.g., inkjet printing) head, so as to avoid clogging of the dispensing (e.g., inkjet printing) head by the formulation in case its viscosity is too high.

In some embodiments, the heating is executed by heating the dispensing (e.g., inkjet printing) heads, at least while passing the modeling material formulation(s) through the nozzle of the dispensing (e.g., inkjet printing) head.

Once the uncured building material is dispensed on the receiving medium according to the computer object data (e.g., printing data), the method optionally and preferably continues to 203 at which a curing condition (e.g., curing energy) is applied to the deposited layers, e.g., by means of a radiation source as described herein. Preferably, the curing is applied to each individual layer following the deposition of the layer and prior to the deposition of the previous layer.

The applied curing condition may optionally comprise application of a single curing condition which cures all of the dispensed building materials (e.g., first and second modeling material formulation, and optional support material formulation), or alternatively, different conditions are applied in order to cure different building materials (e.g., wherein the first and second modeling material formulations are cured by different curing conditions, and/or wherein modeling material formulations and support material formulation(s) are cured by different curing conditions). It is preferable to utilize the same curing condition for different building materials, and the building materials may optionally be selected (as described herein) to allow such curing.

In some embodiments, applying a curing energy is effected under a generally dry and inert environment, as described herein.

In some of any of the embodiments described herein, the method further comprises applying an electroless metal deposition at 205 to the cured modeling material, as described in detail elsewhere herein. Applying of electroless metal deposition at 205 is optionally preceded by one or more treatments, typically aimed at enhancing the efficacy of electroless metal deposition at 205. Examples of such treatments include, for example, activating the promoter of electroless metal deposition at 204, according to any of the respective embodiments described in detail elsewhere herein (e.g., with respect to particular electroless deposition promoters and particular processes suitable for activating them), and treatment with an etchant according to any of the respective embodiments described herein.

The method ends at 206.

In some embodiments, the method is executed using an exemplary system as described herein in any of the respective embodiments and any combination thereof.

The modeling material formulation(s) can be contained in a particular container or cartridge of a solid freeform fabrication apparatus or a combination of modeling material formulations deposited from different containers of the apparatus.

In some embodiments, at least one, or at least a few (e.g., at least 10, at least 20, at least 30 at least 40, at least 50, at least 60, at least 80, or more), or all, of the layers is/are formed by dispensing droplets, as in 202, of a single modeling material formulation, as described herein in any of the respective embodiments.

In some embodiments, at least one, or at least a few (e.g., at least 10, at least 20, at least 30 at least 40, at least 50, at least 60, at least 80, or more), or all, of the layers is/are formed by dispensing droplets, as in 202, of two or more modeling material formulations, as described herein in any of the respective embodiments, each from a different dispensing (e.g., inkjet printing) head or a different array of nozzles as described herein.

These embodiments provide, inter alia, the ability to select materials from a given number of materials and define desired combinations of the selected materials and their properties. According to the present embodiments, the spatial locations of the deposition of each material with the layer is defined, either to effect occupation of different three-dimensional spatial locations by different materials, or to effect occupation of substantially the same three-dimensional location or adjacent three-dimensional locations by two or more different materials so as to allow post deposition spatial combination of the materials within the layer, thereby to form a composite material at the respective location or locations.

Any post-deposition combination or mix of modeling materials is contemplated. For example, once a certain material is dispensed it may preserve its original properties. However, when it is dispensed simultaneously with another modeling material or other dispensed materials which are dispensed at the same or nearby locations, a composite material having a different property or properties to the dispensed materials is formed.

Some of the embodiments thus enable the deposition of a broad range of material combinations, and the fabrication of an object which may consist of multiple different combinations of materials, in different parts of the object, according to the properties desired to characterize each part of the object.

In some of these embodiments, the two or more modeling material formulations are dispensed in a voxelated manner, wherein voxels of one of said modeling material formulations are interlaced with voxels of at least one another modeling material formulation.

Some embodiments thus provide a method of layerwise fabrication of a three-dimensional object, in which for each of at least a few (e.g., at least two or at least three or at least 10 or at least 20 or at least 40 or at least 80) of the layers or all the layers, two or more modeling formulations are dispensed, optionally and preferably using system 10 or system 110. Each modeling formulation is preferably dispensed by jetting it out of a plurality of nozzles of a printing head (e.g., head 16). The dispensing is in a voxelated manner, wherein voxels of one of said modeling material formulations are interlaced with voxels of at least one another modeling material formulation, according to a predetermined voxel ratio.

Such a combination of two or more modeling material formulations at a predetermined voxel ratio is referred to as digital material (DM).

The phrase “digital materials”, abbreviated as “DM”, as used herein and in the art, describes a combination of two or more materials on a microscopic scale or voxel level such that the printed zones of a specific material are at the level of few voxels, or at a level of a voxel block. Such digital materials may exhibit new properties that are affected by the selection of types of materials and/or the ratio and relative spatial distribution of two or more materials.

In exemplary digital materials, the modeling material of each voxel or voxel block, obtained upon curing, is independent of the modeling material of a neighboring voxel or voxel block, obtained upon curing, such that each voxel or voxel block may result in a different model material and the new properties of the whole part are a result of a spatial combination, on the voxel level, of several different model materials.

Herein throughout, whenever the expression “at the voxel level” is used in the context of a different material and/or properties, it is meant to include differences between voxel blocks, as well as differences between voxels or groups of few voxels. In preferred embodiments, the properties of the whole part are a result of a spatial combination, on the voxel block level, of several different model materials.

In some of any of the embodiments of the present invention, once the layers are dispensed as described herein, exposure to curing energy as described herein is effected. In some embodiments, the curable materials are UV-curable materials and the curing energy is such that the radiation source emits UV radiation.

In some embodiments, where the building material comprises also support material formulation(s), the method proceeds to removing the hardened support material (e.g., thereby exposing the adjacent hardened modeling material). This can be performed by mechanical and/or chemical means, as would be recognized by any person skilled in the art. A portion of the support material may optionally remain upon removal, for example, within a hardened mixed layer, as described herein.

In some embodiments, removal of hardened support material reveals a hardened mixed layer, comprising a hardened mixture of support material and modeling material formulation. Such a hardened mixture at a surface of an object may optionally have a relatively non-reflective appearance, also referred to herein as “matte” (and the corresponding dispensing of support material formulation adjacent to modeling material formulation is referred to as “matte mode”); whereas surfaces lacking such a hardened mixture (e.g., wherein support material formulation was not applied thereon) are described as “glossy” in comparison (and the corresponding dispensing of formulation is referred to as “glossy mode”).

In some embodiments, the hardened mixed layer comprises functional groups (e.g., carboxylic acid groups) which promote electroless metal deposition by binding to a catalyst in an activating substance, or which are converted (e.g., by oxidation) to such functional groups (e.g., hydroxyl groups oxidized to carboxylic acid groups), according to any of the respective embodiments described herein.

In some embodiments, the second modeling material formulation is a formulation which is removed (e.g., a supporting material formulation or a similar formulation) in a process such as described herein for removal of supporting material formulation, such that the second modeling material formulation is not necessarily a modeling material formulation used to form the three-dimensional object, and remains in the object only in a hardened mixed layer. Thus, the secondary configured pattern may optionally be formed according to a pattern of a matte surface (as opposed to glossy surface), according to any of the respective embodiments described herein. Such patterning is exemplified in Examples 7A-7C herein.

In some embodiments, the removable second modeling material formulation comprises functional groups (e.g., carboxylic acid groups) which promote electroless metal deposition by binding to a catalyst in an activating substance, or which are converted (e.g., by oxidation) to such functional groups (e.g., hydroxyl groups oxidized to carboxylic acid groups), according to any of the respective embodiments described herein.

In some of any of the embodiments described herein, the method further comprises exposing the cured modeling material, either before or after removal of a support material, if such has been included in the building material, to a post-treatment condition. The post-treatment condition is typically aimed at further hardening the cured modeling material. In some embodiments, the post-treatment hardens a partially-cured material to thereby obtain a completely cured material.

In some embodiments, the post-treatment is effected by exposure to heat or radiation, as described in any of the respective embodiments herein. In some embodiments, when the condition is heat (thermal post-treatment), the post-treatment can be effected for a time period that ranges from a few minutes (e.g., 10 minutes) to a few hours (e.g., 1-24 hours).

In some embodiments, the thermal post-treatment comprises exposing the object to heat of at least 100° C. for at least one hour.

In some embodiments, the thermal post-treatment comprises gradual exposure of the object to heat of at least 200° C., e.g., 250° C. For example, the object is exposed to a first temperature (e.g., 100° C.) for a first time period, then to a second, higher temperature (e.g., 150° C. or 200° C.) for a second time period, then to a third, yet higher temperature (e.g., 200° C. or 250° C.), for a third time period. Each time period can be 10 minutes to 2 hours.

As used herein throughout the term “about” refers to ±10% or ±5%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Materials and Methods

Electroless Copper Deposition Solutions:

Electroless Copper 22 copper bath was prepared by combining components Cu 22A (comprising 75 grams/liter formaldehyde and 31 grams/liter copper) and Cu 22B (comprising 115 grams/liter NaOH) in accordance with the instructions of the manufacturer (MacDermid).

Electroless 7032+7033 copper bath was prepared by combining components 7032 solution (comprising copper) and 7033 solution (comprising NaOH) in accordance with the instructions of the manufacturer (MacDermid).

Electroless Copper 9072 solution was prepared by combining 75% (v/v) deionized water, 15% (v/v) Metex™ PTH Electroless Copper 9072 Concentrate (comprising 3-7 weight percents CuSO4 and 2-6 weight percents formaldehyde) and 10% (v/v) Metex™ PTH Electroless Copper 9073 Reducer (comprising 10-25 weight percents NaOH), in accordance with the instructions of the manufacturer (MacDermid).

MACuDep™ 70 copper system (comprising about 5 grams/liter copper, about 9.5 grams/liter free caustic, about 0.105 M chelator, and about 5.75 grams/liter formaldehyde) was used in accordance with the instructions of the manufacturer (MacDermid), by adding 100 ml/liter MACuDep™ 70-B, 100 ml/liter MACuDep™ 70-A, and 54 ml/liter MACuDep™ 70-C to 746 ml/liter deionized or distilled water, with thorough mixing.

Enplate™ Cu-872 solution was prepared from components obtained from Amza Ltd. (Israel), namely, 60 ml/liter Enplate™ Cu-872 A, 60 ml/liter Enplate™ Cu-872 B, and 20-25 ml/liter Enplate™ Cu-872 C “Improved”, with the balance being deionized water, in accordance with the manufacturer's instructions.

### Example 1

### Modeling Material Formulation Comprising Catalyst of Electroless Deposition

VeroClear™ acrylic-based modeling material formulation for 3D printing was combined with catalytic silver nanoparticles, to obtain a catalyst-containing modeling material formulation. After laborious experimentation, poor stability of the obtained catalyst-containing formulation and poor quality of 3D printing were overcome.

A stock solution of VeroClear™ 3D printing formulation (without photoinitiators) loaded with 30 weight percents Ag particles (obtained from PV NanoCell, Israel) and surfactants was diluted with VeroClear™ formulation (including photoinitiators), to a final concentration of 1, 5 or 10 weight percents Ag (typically 5 weight percents). The average size of the Ag particles was in a range of from 70-260 nm, typically from 70-80 nm (suitable for inkjet).

The stability of the final Ag-containing modeling material formulations used in experiments was confirmed. Initially, dilution of the 30% Ag stock solution resulted in an unstable mixture, which became dark black and exhibited a precipitation of “mud” on the bottom of the vessel. The dilution process was therefore changed in order to reduce shock dilution, the suspected cause of instability. Instead, the VeroClear™ formulation diluent was added to the stock solution drop-by-drop during magnetic stirring. The resulting Ag-containing modeling material formulation was both stable and readily printable.

In addition, the use of 7.5 weight percents Ag instead of 30 weight percents Ag in the stock solution further enhanced stability of the Ag-containing modeling material formulation (at a final concentration of 5 weight percents Ag). Similarly, stock solutions with 5 or 10 weight percents Ag were prepared and diluted with VeroClear™ formulation (as described hereinabove).

In addition, the 3D printing quality was improved by increasing the concentration of the photoinitiators i184 (1-hydroxy-cyclohexyl-phenyl ketone, obtained as Irgacure® 184) and TPO (diphenyl(2,4,6-trimethylbenzoyl)phosphine oxide) in the Ag nanoparticle-containing modeling material formulation to about 3-fold the photoinitiator concentration in VeroClear™ modeling material formulation, by adding a respective amount of photoinitiator to the VeroClear™ formulation used to dilute the stock solution.

This result indicates that the initially observed reduction in printing quality upon addition of nanoparticles is associated with a decrease in UV penetration and/or UV-induced reactivity in the modeling material formulation.

The Ag-containing modeling material formulation (5% Ag) exhibited similar properties to those of the VeroClear™ formulation, e.g., a viscosity of about 14-15 centipoise at 75° C., a surface tension of about 30 dyn/cm², and a UV-reactivity similar to that of VeroClear™ formulation.

### Example 2

### 3D Printed Object with Pattern of Electroless Deposition Catalyst

3D printing was performed using a Connex™ printing system (Stratasys) with VeroClear™ 3D printing formulation and a modeling material formulation comprising an electroless catalyst (Ag nanoparticles), prepared as described in Example 1; using E1 print heads (Ricoh) and standard DM (digital material) mode printing conditions (temperature of 65° C.), voltage range and printing parameters, including jetting parameters and curing parameters suitable for unmodified VeroClear™ formulation.

The support material used in 3D printing was generally SUP706 (Stratasys); although SUP705 (Stratasys) was also used successfully.

In order to reduce material costs, the standard cartridge line was modified to be with direct loading into the preheater, thereby avoiding use of a long pipe and also facilitating work with small formulation quantities.

The catalyst-containing modeling material formulation was applied in a variety of patterns on various 3D-printed models, including on external surfaces (including top, bottom and peripheral surfaces) and/or internal surfaces (e.g., surfaces of cavities, tunnels and pits) which could be exposed later to an applied electroless deposition solution.

Following 3D printing, the support material was removed by water jet and/or jacuzzi, under standard conditions. Exposure to alkaline solution (comprising 1% NaOH and 2% NaSiO3) was for up to 2 days. The temperature was typically room temperature, but temperatures of up to about 40 to 50° C. can be used successfully, depending on model geometry (thin walls are more susceptible to heat-induced damage).

Energy dispersive x-ray spectroscopy confirmed the presence of silver on surfaces where the Ag-containing modeling material formulation was printed, and the absence of silver where unmodified VeroClear™ formulation was printed (data not shown).

An exemplary additive manufacturing process of forming tunnels coated with electroless-deposited copper, according to some embodiments of the present invention, is shown in FIGS. 4B-4E. FIG. 4B shows an exemplary printing system for multi-material deposition of a transparent modeling material formulation and a UV curable catalytic ink containing 5% w/w Ag nanoparticles. FIG. 4C shows the resulting printed objects made of a hardened transparent material and a brown catalytic ink pattern. FIG. 4D shows an electroless copper plating setup comprising a solution for electroless deposition of copper on treated and activated surfaces as described hereinabove. FIG. 4E shows a final object on which copper has been selectively deposited on the catalytic ink pattern within the printed tunnels.

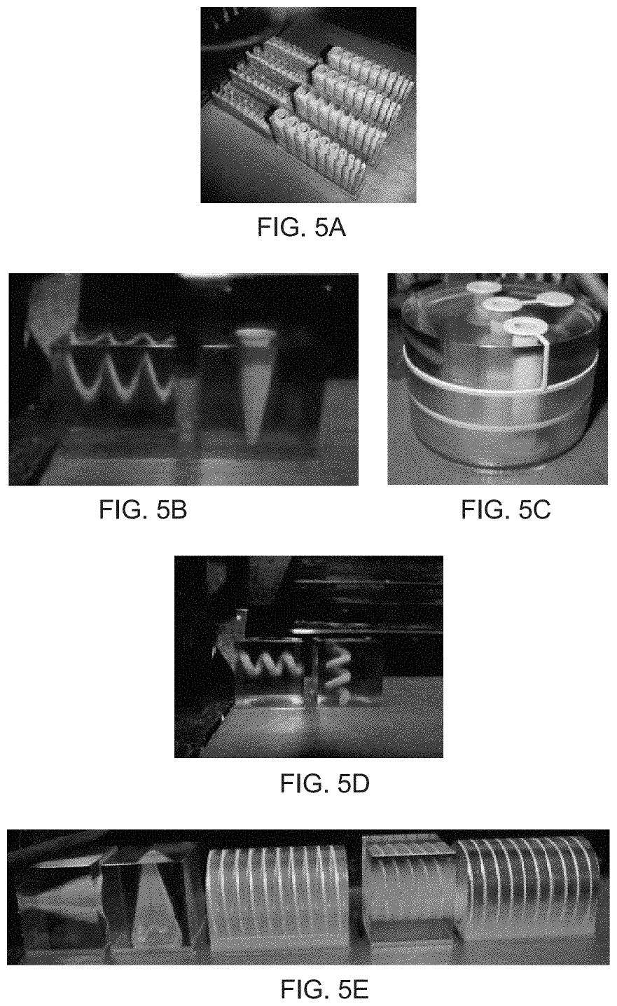

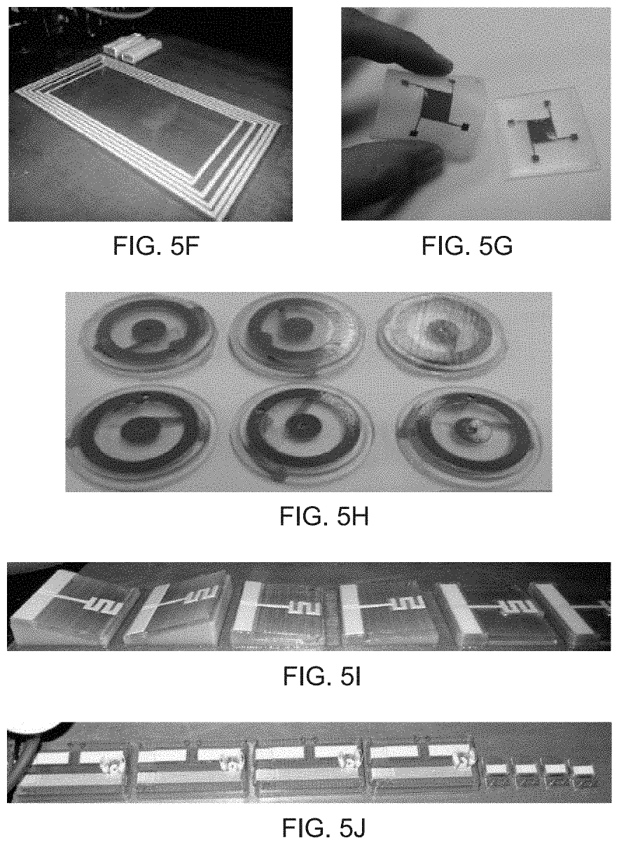

Exemplary 3D-printed objects with a modeling material formulation comprising catalytic Ag nanoparticles are shown in FIGS. 5A-5J.

Modeling material formulation comprising catalytic Ag nanoparticles was applied to vertical surfaces, which exhibited roughness, at a thickness of 240 μm, so that the roughness did not negate electrical conductivity due to lack of layer continuity. The nanoparticle-containing modeling material formulation was typically applied to (smoother) horizontal surfaces at a thickness of 120 μm.

### Example 3

### Electroless Deposition of Copper on 3D Printed Object Using Etching Treatment

The present inventors have uncovered, while performing laborious experimentation, that in order to perform a successful electroless deposition onto objects featuring patterned conductive ink, treatment of the surface should be performed prior to exposing the printed object to electroless deposition solution.

3D-printed objects comprising a pattern of Ag nanoparticle catalysts (prepared according to procedures described in Example 2) were exposed to an activation solution comprising 2% Ag nanoparticles in DGME (diethylene glycol methyl ether) for about 10 minutes. The activation solution was prepared by diluting a commercially available I50DM-106 conductive ink comprising 50% Ag (PV NanoCell, Israel) in DGME. Without being bound by any particular theory, it is assumed that the Ag nanoparticles in the printed object serve as nucleation centers onto which Ag particles present in the activation solution are selectively deposited, thereby increasing the concentration of Ag nanoparticles in the patterned surface.

In initial feasibility studies, exposure to the activation solution was followed by electroless copper deposition using an Enplate™ Cu-872 electroless copper solution (prepared as described hereinabove), resulting in incomplete copper deposition, especially on horizontal surfaces and/or surfaces printed in matte mode (i.e., wherein surfaces were covered with support material formulation, thereby forming a thin mixed layer of modeling material formulation and support material formulation) rather than glossy mode (i.e., wherein surfaces were not covered with support material formulation).

Abrasive blasting of a catalyst-containing surface of a 3D-printed model was observed to enhance the efficacy of activation and subsequent electroless deposition.

The effect of chemical etching was then assessed, as it was hypothesized that catalytic silver particles become enveloped by the polymerized matrix, thereby interfering with the electroless deposition, and that chemical etching may expose such particles.

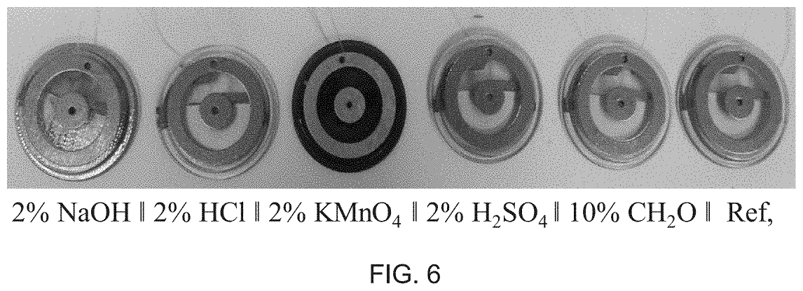

As shown in FIG. 6, 2% KMnO₄ was more effective than 2% NaOH, 2% HCl, 2% H₂SO₄, 2% KIO₄ or 10% formaldehyde at enhancing copper plating formed by electroless deposition (using an Enplate™ Cu-872 electroless copper solution, as described hereinabove). The copper plating obtained following treatment with 2% KMnO₄ exhibited a resistance of only 0.3Ω (between two end points of the outer copper pattern).

As shown in FIG. 8, treatment of a 3D printed polymeric matrix to 0.1%, 0.5%, 1% or 2% KMnO₄ prior to electroless copper deposition resulted in a copper plate quality correlated to the KMnO₄ concentration. However, high concentrations of KMnO₄ also reduced the selectivity of deposition (not shown).

Exposing 3D printed models to 5% KMnO₄ for 15-60 minutes prior to activation with Ag solution resulted in considerable enhancement of the quality of copper deposition on printed objects.

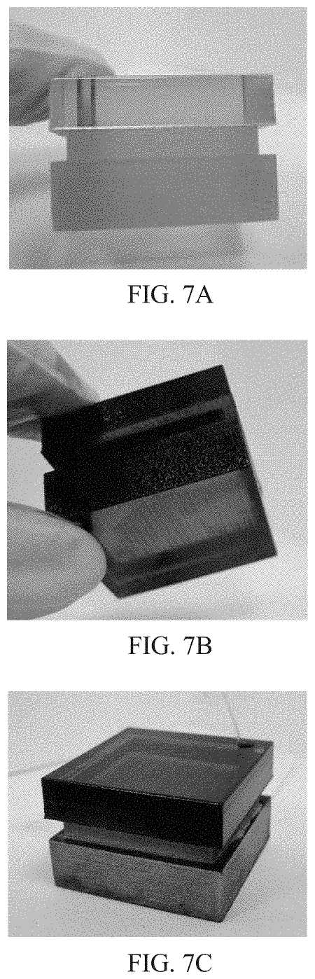

As shown in FIGS. 7A-8, KMnO₄ colored the hardened modeling material formulation brown. This brown color was successfully neutralized by treatment with 5% H₂SO₄ and H₂O₂ (not shown).

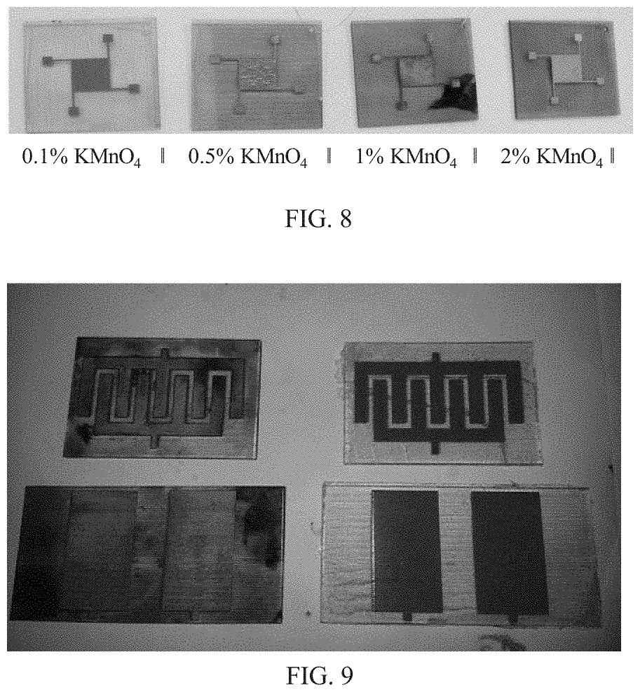

In order to confirm the functionality of 3D printed models, two capacitive sensors were prepared by 3D printing followed by treatment with 5% KMnO₄ for 30-60 minutes, activation with a 2% Ag solution, and electroless copper deposition, according to procedures described hereinabove. The capacitive sensors are shown in FIG. 9, as well as their corresponding 3D-printed intermediates, prior to treatment with KMnO₄ and electroless deposition.

The capacitive sensors were capable of detecting the proximity of a variety of substances with different dielectric constants, thereby indicating electric functionality of the 3D-printed objects with electroless deposition.

In addition, an antenna such as described by Cook et al. [Electronic Materials Letters 2013, 9:669-676] was prepared by 3D printing followed by treatment with 5% KMnO₄ for 30-60 minutes, activation with a 2% Ag solution, and electroless copper deposition, according to procedures described hereinabove (instead of on paper, as described by Cook et al. [Electronic Materials Letters 2013, 9:669-676]). The antenna is shown in FIG. 10, as well as its corresponding 3D-printed intermediates, prior to treatment with KMnO₄ and electroless deposition.

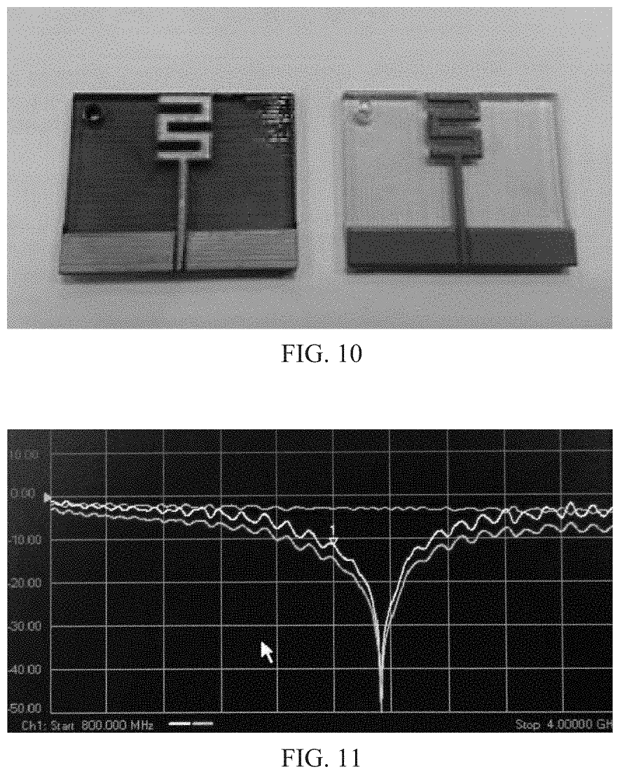

As shown in FIG. 11, the antenna prepared by 3D printing and electroless copper deposition (as described hereinabove) exhibited considerable insertion loss, indicating functionality of the antenna.

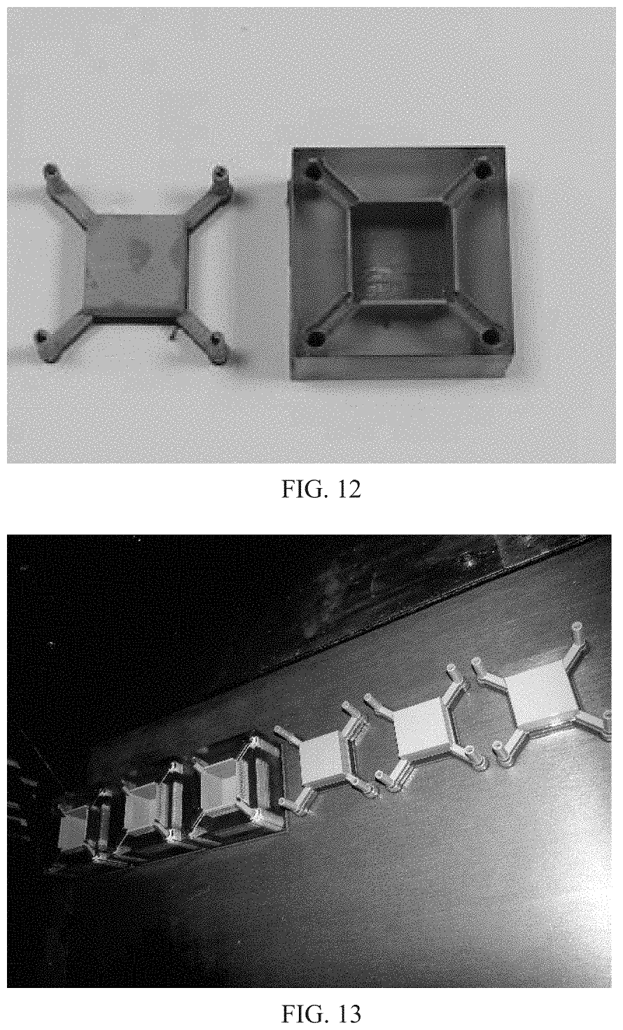

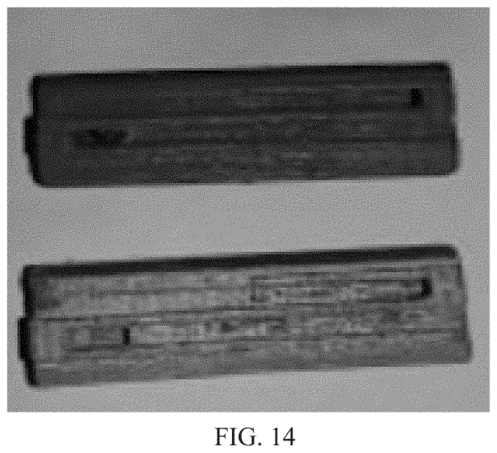

FIGS. 12 and 13 show the preparation of two-component electromagnetic interference (EMI) shields, wherein each component was prepared by 3D printing according to procedures described hereinabove (FIG. 12), followed by activation with PdCl₂ solution and electroless copper deposition according to procedures described hereinabove (FIG. 13).

Similarly, a button for switching on an electric device was prepared by forming each of two components of the button by 3D printing according to procedures described hereinabove (not shown). Upon simple assembly of the two components, the button was capable of turning a light bulb on and off upon pressing and release of the button, respectively.

### Example 4

### Electroless Deposition of Copper on 3D Printed Object by Activating Acrylic Acid-Containing Modeling Material Formulation

As shown in FIGS. 7A-7C, treatment with KMnO₄ as described in Example 3 was capable of inducing selective electroless copper deposition on matte areas (as opposed to glossy areas) without printing catalyst-containing modeling material formulation.

It was hypothesized that the abovementioned deposition of copper on areas without catalyst-containing modeling material formulation was associated with oxidation of hydroxyl groups in the hardened formulation (which originate in the support material formulation mixed into surface of the matte area) to carboxylic acid groups which bind Ag nanoparticles during the activation process, thereby promoting copper deposition.

The use of a modeling material formulation comprising carboxylic acid groups (such as in acrylic acid) to bind catalyst particles (upon activation) instead of a modeling material formulation comprising incorporated catalyst particles to promote electroless copper deposition was then assessed.

Acrylic acid was added to VeroClear™ modeling material formulation (without Ag particles) at a concentration in a range of from 5-50%. 3D-printed models were prepared according to procedures described in Example 2, except that the aforementioned acrylic acid containing formulation was used instead of an Ag-containing formulation as a promoter of electroless deposition. The 3D-printed models were then exposed to an activation solution comprising 2% Ag nanoparticles in DGME, followed by electroless deposition of copper, according to procedures described in Example 3 hereinabove. Selective copper deposition was obtained in accordance with the printed pattern of the acrylic acid-containing modeling material formulation.

These results indicate that catalyst-binding formulations as well as catalyst-containing formulations can be used to promote selective electroless deposition on 3D-printed objects.

### Example 5

### Electroless Deposition of Copper on 3D Printed Object Using Palladium Chloride Solution for Activation

Catalyst-containing modeling material formulation was used in 3D printing, according to procedures described in Example 2.

An activation solution containing palladium (II) chloride was then utilized for electroless deposition (without prior treatment with a chemical etchant). The activation solution was prepared by combining about 5-10 ml/liter MACuPlex™ D-45C PdCl₂-containing solution (MacDermid Israel) with about 50 ml/liter concentrated HCl and about 935-945 ml/liter deionized water, according to the manufacturer's instructions (although the solution is typically used for activating different types of surfaces), to obtain an activation solution comprising about 14-30 ppm palladium and about 0.55-0.65 N acid.

Printed models were exposed to this activation solution for 3 minutes at a temperature of 50° C. (although lower temperatures were tested and also found to be satisfactory).

Upon exposure to the activation solution, the brown-gray Ag-containing modeling material formulation (5% Ag) pattern became black due to reduction of the Pd(II) to Pd(0) (the active electroless catalyst) by the silver nanoparticles of the formulation, thereby providing a rapid indication of catalyst activation.

In matte mode, satisfactory catalyst activation was obtained on all tested surface orientations in all tested models; whereas in glossy mode, poor activation occasionally occurred on horizontal surfaces.

The models were then washed with distilled water and exposed to any of a variety of electroless deposition solution baths prepared as described hereinabove (according to manufacturer's instructions).

The Electroless Copper 22 copper bath (MacDermid) and 7032+7033 copper bath, at a temperature of about 21-26° C., were each effective for thin copper deposition (e.g., about 2 μm). Thicker layers of copper can be obtained by long exposure to the solution. The obtained copper layers typically exhibited good adhesion to the printed object.

The MACuDep™ 70 high speed electroless copper system (MacDermid) at a temperature of about 37° C. was effective for thick copper deposition, at a relatively consistent and high deposition rate.

As standard electroless deposition typically exhibits a decrease in deposition rate due to covering of the palladium by copper (and in a batch reactor, possibly also due to copper consumption, pH change and/or accumulation of impurities), the above result indicates that an autocatalytic process within the MACuDep™ 70 copper system reduces the degree to which the deposition rate decreases over time. Vibration may optionally be used to avoid trapping of hydrogen gas within the rapidly deposited copper layers.

In addition, thick copper deposition with good adhesion was also obtained by depositing a thin layer of copper using exposure to the Electroless Copper 22 copper bath, as described hereinabove, for 30-60 minutes, followed by exposure to the MACuDep™ 70 copper system as described hereinabove (without washing or reactivation between solutions).

Similarly, the Enplate™ Cu-872 solution (AMZA Ltd.) was effective for copper deposition at a temperature of about 45° C.

Representative 3D-printed objects before and after copper plating upon activation with a PdCl₂ solution are shown in FIG. 14.

Air bubbling in the electroless deposition solutions is optionally performed (e.g., using typical aquarium equipment such as air pump and air diffuser). Air bubbling may enhance stability of copper deposition and/or facilitate mixing, at the possible expense of a slower deposition rate.

### Example 6

### Electroless Deposition of Copper on 3D Printed Object Using Alternative Modeling Material Formulations

3D-printed models with patterns of catalyst-containing modeling material formulation (prepared as described in Example 1) were prepared and subjected to electroless copper deposition, using procedures described in Examples 2, 3 and 5, except that VeroWhite™ Helios™, ABS (acrylonitrile butadiene styrene)-like (white and green) or Rigur™ (stiff) modeling material formulations, or Agilus™ rubber-like modeling material formulation, were used instead of VeroClear™ formulation as bulk modeling material formulations.

Satisfactory 3D printing and selective electroless copper deposition were obtained (not shown) with stiff and rubber-like materials, printed in matte and glossy modes (rubber-like materials were tested only in glossy mode), with copper plating typically exhibiting a resistivity in a range of from 3-fold to 5-fold the bulk resistivity of copper.

### Example 7

### Electroless Deposition of Copper on 3D Printed Object Using Palladium Particle

A 3D-printed object with selective electroless copper deposition is prepared according to procedures such as described hereinabove, with the exception that palladium particles are used instead of silver particles in the catalyst-containing modeling material formulation. Optionally, an activation step using a palladium-containing solution (as described hereinabove) is omitted, in view of the presence of palladium in the formulation.

### Example 8

### Electroless Deposition of Copper with Copper Protection on 3D Printed Object

A 3D-printed object with selective electroless copper deposition is prepared according to procedures such as described hereinabove, with the exception that an additional treatment for reducing copper oxidation is included.

The additional treatment optionally comprises application of a commercially available anti-tarnish solution (e.g., obtained from MacDermid), optionally for a time period in a range of from 30 seconds to 5 minutes.

Alternatively or additionally, the additional treatment comprises deposition of a thin (e.g., submicron) layer of silver over the copper, by electroless deposition, using procedures known in the art, and optionally a commercially available solution for electroless deposition of silver (e.g., obtained from MacDermid).

The obtained copper layer on a 3D-printed object is optionally compared with a 3D-printed object with a copper layer without a protective layer (e.g., prepared as described in any of the abovementioned Examples) with respect to resistance to copper oxidation (e.g., tarnishing), using a suitable art-recognized technique.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of additive manufacturing of a three-dimensional object having an agent which promotes electroless metal deposition dispersed in and/or on at least a portion thereof, the method comprising sequentially forming a plurality of layers in a configured pattern corresponding to the shape of the object, thereby forming the object, wherein said agent is dispersed in and/or on said portion of the object in a secondary configured pattern,
wherein the formation of at least a few of said layers comprises:
dispensing a first modeling material formulation which comprises a first curable material; and
dispensing a second modeling material formulation which comprises a second curable material and said agent which promotes electroless metal deposition,
wherein dispensing said first and said second modeling material formulations is according to said secondary configured pattern.

2. The method of claim 1, wherein said second modeling material formulation comprises a support material formulation, the method further comprising removing a portion of said support material formulation.

3. The method of claim 2, further comprising treating said support material formulation with an oxidant to form said agent which promotes electroless metal deposition.

4. The method of claim 1, wherein said secondary configured pattern is on an external surface of the object and/or on an internal surface of the object.

5. The method of claim 1, wherein said agent is a catalyst of electroless metal deposition.

6. The method of claim 1, wherein said catalyst comprises silver particles and/or palladium particles.

7. A method of manufacturing of a three-dimensional object comprising an electrically conductive material dispersed in and/or at least a portion of the object in a secondary configured pattern, the method comprising:
forming, by additive manufacturing according to the method of claim 1, a three-dimensional object having an agent which promotes electroless metal deposition dispersed in and/or on at least a portion thereof in said secondary configured pattern; and
contacting said three-dimensional object having an agent which promotes electroless metal deposition dispersed in and/or on at least a portion thereof in said secondary configured pattern with an electroless deposition solution capable of forming an electrically-conductive layer in the presence of said agent, to thereby form the electrically-conductive material in and/or on the surface of the object according to said secondary configured pattern.

8. The method of claim 7, further comprising activating said agent in said secondary configured pattern prior to said contacting with an electroless deposition solution, to thereby form an activated catalyst of electroless metal deposition dispersed in the object in said secondary configured pattern.

9. The method of claim 8, wherein said activating is effected by contacting said agent with an activating substance comprising Pd(II) and/or silver particles.

10. The method of claim 9, wherein said activating substance comprises PdCl₂ and HCl.

11. The method of claim 8, wherein said activating substance comprises a catalyst of electroless metal deposition, and said agent binds to said catalyst, to thereby form said activated catalyst bound to said agent.

12. The method of claim 7, further comprising treating said object having an agent which promotes electroless metal deposition dispersed in and/or on at least a portion thereof in said secondary configured pattern with a chemical etchant solution prior to said contacting with an electroless deposition solution.

13. The method of claim 12, wherein said etchant comprises a permanganate.

14. The method of claim 13, further comprising contacting said object with a bleaching composition subsequent to said treating with said etchant.

15. The method of claim 7, wherein said electroless deposition solution comprises a metal ion and a reducing agent.

16. The method of claim 15, wherein said metal is selected from the group consisting of copper, nickel, silver and gold.

17. A three-dimensional object having an agent which promotes electroless metal deposition dispersed in and/or on at least a portion thereof in a configured pattern, manufactured according to the method of claim 1.

18. The method of claim 1, wherein said additive manufacturing is inkjet 3D printing.

19. The method of claim 1, wherein said second modeling material formulation further comprises an electroless deposition promoter.

20. The method of claim 19, wherein said electroless deposition promoter is a (meth)acrylic acid or an oligomer thereof.

21. The method of claim 5, wherein a concentration of said agent in said second modeling material formulation is in a range of from 1 to 10 weight percent.
